(19) United States
(12) Patent Application Publication
(10) Pub. No.: US 2010/0145734 A1
(43) Pub. Date: Jun. 10, 2010

(54) Automated claims processing system

(76) Inventors: Manuel Becerra, Miami, FL (US); Maria C. Manduley, Miami, FL (US)

Correspondence Address: GLEN E. SCHUMANN;C/O MOSS & BARNETT, 90 SOUTH SEVENTH STREET, 4800 WELLS FARGO CENTER, MINNEAPOLIS, MN, 55402-4129, US

(21) Appl. No.: 12/313,740

(22) Filed: Nov. 24, 2008

Related U.S. Application Data
(60) Provisional application No. 61/004,587, filed on Nov. 28, 2007.

(51) Int. Cl. G06Q 40/00; G06N 5/02; G06Q 10/00

(52) U.S. Cl. 705/4; 706/52

(57) ABSTRACT

A computer system-based automated loss verification system for evaluating the validity of claims filed under an insurance policy or debt protection contract is provided by this invention. Instead of requiring the claimant to contact the insurance company or lender to file the claim and provide exhaustive documentary proof of the validity of the claimed loss, the system pre-scores the relative risk of the claim using a risk assessment tool based upon predictive modeling and a number of potential risk factors. The associated automated loss verification tool uses this risk score and other information connected with the claim to assign a relative confidence level of proof of valid loss that must be satisfied before the claim can be approved through the adjudication process, and assigns a third-party supplied source or combination of sources of proof that can be automatically accessed by the system to validate the claim.

### CROSS-REFERENCE TO RELATED APPLICATION

This application claims priority to U.S. Provisional Application 61/004,587 filed on Nov. 28, 2007, which is hereby incorporated by reference in its entirety.

### FIELD OF THE INVENTION

This invention relates generally to the processing of insurance policy claims submitted by policyholder customers, and more specifically to a system for automatically processing such claims by the insurance company through a validation process that relies upon third-party-supplied data for the credibility of the claim.

### BACKGROUND OF THE INVENTION

Insurance represents a means for providing protection against financial loss in a variety of situations. For instance, life insurance helps to replace income lost to a family if a wage-earner parent dies. Health insurance helps to pay medical bills if a wage earner or family member becomes sick. Fire insurance pays all or a portion of the loss if a policyholder's home or building is destroyed by fire. Automobile or marine insurance helps to cover the costs of damages resulting from a car or boat accident.

Insurance works on the principle of sharing losses between people. People who desire to be insured against particular types of losses agree to make regular premium payments to an insurance company, who in return will provide a contract called a “policy.” In essence, the company promises to pay the policyholder a certain sum of money for the types of losses identified in the policy. The insurance company will use the premiums to buy stocks, bonds, mortgages, government securities, and other income-producing investments to generate additional money with which to pay, in combination with the premiums collected from all the policy holders, all of the collective benefits or claims that are owed under the policies.

Insurance works because policyholders are willing to trade a small but certain loss in the form of the premium payment for the contractual guarantee that they will be indemnified (i.e., paid) in case of a larger but unpredictable loss. Although a policyholder may never receive any benefits from an insurance company under the policy, the premiums have not been wasted, because the insurance policy provides the policyholder a feeling of security. Therefore, the policyholder can own property, drive a car, operate a business, and engage in many other activities—even potentially risky ones—without worrying about the financial losses that may occur.

An important benefit traditionally provided by many employers to their employees is disability insurance. Such a disability insurance policy is a form of “sponsored insurance” or “group insurance,” and it causes the underlying insurance company to pay the worker a portion of his lost income while he is disabled and therefore unable to work on the job, or work fewer hours than normal. Disability will typically constitute a limitation upon the worker from performing the material and substantial duties of his regular occupation due to sickness or injury, coupled with a threshold loss in monthly earnings due to the same sickness or injury. The group disability policy may also cover the worker, after an initial period of benefits, for loss of income from his regular occupation if he then is disabled from working in any gainful occupation for which he is suited by training, education, and/or experience. The policy may cover the worker's disability for a short initial time frame (“short-term disability”), or for a longer time frame after the worker's disability has continued for a specified “elimination period” like 90 days (“long term disability”). Once the elimination period has passed and the worker is still disabled, he will typically receive a payment amounting to a percentage (e.g., 60%) of his monthly earnings that he earned before the disability began up to a capped amount for the duration of his disability. However, disability insurance policies may also cap the duration of benefit payments to further mitigate their risk.

Besides life, fire, and disability insurance, other forms of risk protection coverage sought by customers include unemployment insurance and “debt protection.” An unemployment insurance policy pays the individual and his beneficiary in the event of involuntary unemployment. In simplistic terms, debt protection is similar to credit life, disability, and involuntary unemployment insurance, but instead of being an insurance policy, it is an amendment to the credit agreement whereby, for a fee, the lender will defer or cancel all or part of a debt upon the death, disability, or involuntary unemployment of a borrower. There is also leave of absence coverage, where if one has to take a leave due to the birth of a child, the debt is deferred or cancelled in part.

Insurance companies and lenders are generally prepared and willing, under the circumstances covered by their insurance or protection program contracts, to provide the policyholder and their beneficiaries with the benefits specified by the policy or terms and conditions of the program. However, before honoring such commitments, insurers and lenders alike must validate that the circumstances of the event reported by the policyholder or beneficiary truly occurred, and fit within the terms of the policy or contract. This is because the premium charged by the insurance company or lender for the policy or contract was originally calibrated to reflect the risk of the covered event occurring, based upon the laws of probability and actual experience with the policyholder. Combined with the probable benefit amounts that will need to be paid to such policyholders who are likely to die, become disabled, become involuntarily unemployed, etc. within the policy coverage limits, the insurance company or lender can price the policy to cover such losses, cover the insurance company's costs of running its business, and provide a reasonable profit to the shareholders (or policyholders for a mutual insurance company). However, if payments are made upon fraudulent or erroneous claims of policy coverage, then the solvency of such insurance programs may be placed at risk with a consequent need for increased premium rates charged to consumers.

Therefore, insurers and lenders alike have developed processes to validate the claims filed by the policyholder. Such industry loss validation processes typically consist of several data collection steps conducted to determine the nature of the event and to validate the actual occurrence of the event. Insurance policy providers typically require a claimant to call a telephone number to provide mailing information to receive a claim form. Then the claimant must respond to a variety of questions set forth within the claim form. They also require the claimant to provide proof that the covered event actually occurred. For example, in the event of a death under a life insurance policy, the claimant might be required to provide a death certificate or a copy of the autopsy report. In the event of disability, the claimant might be asked to provide a form from a doctor stating that the covered person is disabled or unable to work. For unemployment, the covered person might be required to provide proof that he filed a claim with his state's unemployment office.

These requirements for submission of proof of the covered event are typically made for all customers without regard to the actual risk of fraud or customer error. The insurance company or leader simply seeks to prove that all the claimants are eligible for all of the benefits that they claim. Of course, this validation process is very paper-intensive and requires follow up investigation by insurance company employees before a decision can be made whether to pay the claimant. It is also costly from an administrative standpoint, thereby contributing to healthcare and insurance costs that are already experiencing persistent upward pressures from increasing medical and pharmaceutical costs. While the insurance industry strives to pay claims within ten days of their approval, it is not unusual for the claim investigation and validation process to take thirty days. Given the fact that the claimant may have waited 30-60 days after the loss event to report the claim, the claimant's perception may be that it took 70-100 days for payment to be made by the insurance company, which can seem very long, indeed. Moreover, intensive evidentiary proof requirements imposed by the insurance company upon beneficiaries grieving the loss of a deceased policyholder may seem insensitive and unnecessary.

Various efforts have been made within the insurance industry to streamline this administrative process for reviewing and adjudicating payment requests from or on behalf of insured beneficiaries. For example, within the healthcare industry, healthcare providers will request payment from the patient's insurance company for medical services and supplies provided to the patient. The administration by the insurance company of these payment requests has become increasingly automated whereby technicians at the healthcare provider's office electronically create and submit a medical insurance claim to a central processing system. Information identifying the doctor, patient, medical service, insurer, etc. will typically be included as part of the medical insurance claim. The central processing system then verifies that the doctor, patient, and insurer are, in fact, participants in the claims processing system. After such an automated verification step, the central processing system converts the medical insurance claim into the appropriate format for the particular insurance company, and forwards that claim to the insurer. Upon manual adjudication and approval of the insurance claim by an insurance company employee, the insurer will initiate an electronic transfer of funds to the healthcare provider's bank account. See, e.g., U.S. Published Application 2003/0187695 filed by Drennan.

However, a great deal of time and expense is still required for the insurer to review and approve the medical insurance request after it is received from the central processing system. Because manual review and adjudication is costly, an insurer may choose instead to simply pay a large number of claims with minimal to no review, but this option is suboptimal, since it may fall prey to fraud or error in the claim.

U.S. Published Application 2005/0075912 filed by Bealke et al. discloses an electronic insurance claims settlement system that provides the parties (i.e., insurer and claimant) electronic access to the claims process so that they can monitor its progress. Payment can be promptly wired to the claimant upon approval of the claim, but again this review process leading to this approval decision is manual in nature. U.S. Pat. No. 6,343,271 issued to Peterson et al. provides an electronic system that “pre-adjudicates” a claim before it is submitted by the healthcare provider to indicate to the provider whether the claim will be manually reviewed or summarily paid by the insurer. In this manner, the healthcare provider can tailor its medical insurance claim to improve its odds of obtaining summary payment by the insurer, thereby expediting receipt of payment. See also U.S. Published Application 2002/0019754 filed by Peterson et al.

Other electronic systems are known within the insurance industry for partially automating some aspect of the claims review process. For example, U.S. Published Application 2007/0050219 filed by Sohr et al. teaches a system for checking an insurance claim against previously paid claims for that claimant to prevent duplicate payments. U.S. Published Application 2006/0149784 filed by Tholl et al. specifies a system that pre-examines an insurance claim prior to the manual adjudication to determine whether it states a claim that is covered by the associated insurance policy. Meanwhile, U.S. Published Application 2004/0078247 filed by Rowe III et al. discloses an electronic claims processing system that pre-examines a claim prior to its manual adjudication for completeness and consistency. Any incomplete or internally inconsistent claim can be returned by the system to the claimant for revision to save the time of the manual claims adjudicator, and reduce the number of rejected claims. See also U.S. Published Application 2007/0038484 filed by Hoffner et al.

Other electronic systems exist for helping insurance companies to enhance the efficiency of the insurer-claimant relationship. For example, U.S. Patent Application 2007/0005402 filed by Kennedy et al. teaches a system used by a doctor to determine whether the insurer or patient will pay the bill under the terms of the medical insurance policy. The doctor can use this information to properly submit the invoice, and obtain payment in real time from the patient's Medical Savings Account if available. Nevertheless, the claim must still be adjudicated by the insurer. Therefore insurance companies have implemented technological solutions for assisting this adjudication step.

U.S. Published Application 2005/0038682 filed by Gandee et al. discloses a two-way audio/video communication that enables an insurance company to examine a claimed casualty loss remotely without having to send an adjustor to perform an examination in person. U.S. Published Application 2002/0002475 filed by Freedman et al. provides a system used by a car insurance company for capturing claims information and video images needed for the adjustor to detect fraudulent claims. U.S. Published Application 2004/0117329 filed by Crain discloses a similar system used by the Post Office to adjudicate claims for damaged packages. U.S. Published Application 2004/0093242 filed by Cadigan et al. specifies an electronic system that performs a number of functions related to insurance claims processing, including a module that tracks data necessary for the adjustor to adjudicate the claim.

All such prior art systems, however, require manual adjudication of the insurance claim, and merely capture and manage the information needed for enhanced efficiency in that manual adjudication process. U.S. Pat. No. 7,203,654 issued to Menendez tries to go one step further by providing an electronic system that compares the claims against key word searches, claims history data, and the amount of the claim to determine which subset of those claims are characterized by greater risk of fraud or mistake to especially warrant manual scrutiny and adjudication. All other claims are automatically paid by the insurer without scrutiny and adjudication. See also U.S. Published Application 2007/0150319 filed by Menendez.

The reality is that not all claimants pose the same level of exposure of the insurance company to error or fraudulent activity. Therefore, not all claimants should logically require the same level of verification. The circumstances of a particular case might indicate a higher or lower relative risk of fraud or error associated with a claim. For example, a loss claim filed under a life insurance policy for the death of a policyholder who paid premiums for more than 20 years, who at the time of death is reported to have been 80-years-old, and whose total potential benefit totals $500, does not represent the same level of risk as does a claim for the death of a policyholder who had been paying premiums for only one month, and who is reported to have been 25-years-old at the time of death, with the potential benefit totaling $100,000. The likelihood of death for an 80-year-old is greater than that for a 25-year-old. The likelihood that a claimant would perpetrate fraud for a $500 benefit payment is less than that for a $100,000 benefit when other factors are considered. Moreover, the longevity of the customer relationship impacts the likelihood of fraud.

Among a group of claimants, there is a subgroup whose claims should and will be approved once they are taken through the full series of adjudication steps in the procedure used by the industry to validate the claim. At the same time, the remaining claimants should and will have their claims denied once they progress through the conventional validation process. Unfortunately, it is very difficult to predict in advance the claimant subgroup who should have their claims approved. Menendez's “all-or-nothing” adjudication system is less appealing to an insurer because there is no middle ground between “thorough adjudication” and “no adjudication.” Yet statistical probability suggests that some portion of the non-adjudicated claims will turn out to be fraudulent—albeit perhaps for smaller dollar amounts. Therefore, insurance companies and lenders have tended to force all their claimants to endure the same degree of close scrutiny that should logically only be applied to a few claimants. Meanwhile, insurance companies and lenders incur significant costs associated with this rigorous claims investigation process, which places upward pressure on insurance premiums.

Therefore, providing a streamlined claims processing system that enables claimants to contact the insurance company or lender, provide loss information and receive an acknowledgement and prompt decision concerning payment of their claims from the insurance company or lender based upon some level of review and adjudication would be very advantageous to both the insurance company or bank and claimant alike. Such system should ideally forego the typical required documentary proof provided by the claimant of the covered event at least except for high-risk claimants, and rely instead upon a review and adjudication process based upon readily accessible proofs provided by third-party data sources.

### SUMMARY OF THE INVENTION

A computer system-based automated loss verification system for evaluating the validity of claims filed under an insurance policy or debt protection contract is provided by this invention. Instead of requiring the claimant filing the claim with the insurance company or lender to provide exhaustive documentary proof of the validity of the claimed loss, the system pre-scores the relative risk of the claim using a risk assessment tool based upon predictive modeling and a number of potential risk factors, including, but not limited to, the amount of the claim, the nature and probability of the loss, the history of the claimant with respect to the policy or contract, and the insurance company's or lender's history with other similar claims. The associated automated loss verification tool uses this risk score and other pertinent information connected with the claim to assign a relative confidence level of proof of valid loss that must be satisfied before the loss can be verified through the automated adjudication process. The system also assigns a third-party supplied source or combination of sources of proof that can be automatically accessed by the system to validate the claim. Once the required proof necessary for addressing the relative risk of the claim being fraudulent or invalid is achieved, the claim is approved, thereby avoiding the need for further effort by the claimant to provide documentary evidence. In this manner, the automated loss verification system of the present invention can evaluate and approve claims extremely quickly by insurance industry standards—within two business days, preferably within two hours of the claimant activating the claim by telephone, Internet website, or IVR portal, more preferably within real time as the claimant activates the claim—without requiring the claimant to independently source and provide documentary proof of the claimed loss. Such a system increases the efficiency of the insurance company's or lender's claims adjudication process, while improving its claims experience for the claimant.

### BRIEF DESCRIPTION OF THE DRAWINGS

In the accompanying drawings:

FIG. 1 is a schematic illustration of the surrounding environment of the automated claims processing system of the present invention.

FIG. 2 is a schematic illustration of a computer embodiment for the automated claims processing system.

FIG. 3 is a flow diagram illustrating the automated claims processing system.

FIG. 4 is a schematic illustration of the hardware components for the risk assessment tool and automated loss verification tool portions of the automated claims processing system.

FIG. 5 is an illustration of the application of the automated loss verification system to a life insurance policy.

FIG. 6 is an illustration of the application of the automated loss verification system to an involuntary unemployment insurance policy.

FIG. 7 is an illustration of the application of the automated loss verification system to a disability insurance policy.

FIGS. 8-10 are flow diagrams illustrating the automated claim processing system.

FIGS. 11-12 are schematic illustrations of the risk assessment process portion of the automated loss verification system.

FIGS. 13-25 are screenshots depicting different functionalities of the management console portion of the automated loss verification system.

FIG. 26 is a schematic illustration of the control testing environment module of the invention.

### DETAILED DESCRIPTION OF THE PREFERRED EMBODIMENT

An automated system and method for processing claims under a beneficial coverage contract in a streamlined fashion with prompt communication of a payment or benefits decision to the claimant and minimal evidentiary proof required of the claimant is provided by the invention. Such invention may take the form of an automated claim processing system for receiving information from the claimant necessary to define the nature of the claim and communicate the ultimate decision to the claimant whether or not the claim will be paid or other benefit provided, based upon verification and the rules set forth within the beneficial coverage contract. The claim processing system then sets up a detailed summary of the claim based upon the information provided by the claimant concerning the covered event. A risk assessment tool is then applied to attribute a score to the claimant and the claim to define the risk of a fraudulent or erroneous claim. The system then applies an automated loss verification tool to assign a relative confidence level required for payment or other benefits approval based upon the nature of the claim, as well as one or more independent data validation sources that must be consulted before adjudication of the claim can occur. A single or combination of such independent data sources may establish the basis for validation of the claim, leading to an affirmative payment or other benefits approval decision by the system, without the need for manual verification by the claimant and beneficial coverage contract insurer company personnel.

In the context of the present application, “beneficial coverage contract” means any contractual right by an individual to receive a payment or other benefit as the result of the occurrence of a contractually covered event, such as a death, disability, fire, or unemployment. Examples of such a beneficial coverage contract include without limitation an insurance policy or debt protection product.

For purposes of the present invention, “insurance policy” means any contractual agreement by a corporate or mutual insurance company to provide an individual or group of individuals protection against financial loss arising from the occurrence of a covered event, including but not limited to death, disability, illness or injury, fire, or damage to real or personal property. Thus, insurance includes without limitation short-term or long-term disability insurance, health insurance, critical illness insurance, dental insurance, term life insurance, whole life insurance, universal or variable life insurance, annuities, fire insurance, homeowner's insurance, tornado or hurricane insurance, flood insurance, automobile insurance, marine insurance, and other forms of property and casualty insurance.

For purposes of the present invention, “debt protection product” means a contractual arrangement between a borrower and a financial institution extending credit to the borrower whereby, in return for a fee, the financial institution agrees to suspend required monthly principal repayments or interest payments upon a credit transaction, or even forgive all or a portion of the principal repayment obligations in the event that the borrower sustains a life event, such as death, disability, or unemployment, that would make it difficult for the borrower to honor his obligation to repay the debt.

For purposes of this application, “financial institution” means any commercial, non-profit, government or other entity in the business of furnishing necessary funds to a customer for a retail goods/service transaction, so that such customer need not pay cash for that transaction. Examples of such financial institutions include without limitation banks, savings and loan institutions, credit unions, and credit arms of retail merchants.

As used within this application, “disability” means any limitation by an individual in performing the material and substantial duties of his or her regular occupation due to sickness or injury causing a minimum predetermined percent loss in that person's monthly earnings due to that sickness or injury.

For purposes of the present invention, an “underwriter” is the person within an insurance company, financial institution, or third-party administrator, who must determine the premium rates for various kinds of beneficial coverage contracts, and the amount and degree of risk to be assumed by the insurance company or financial institution for each such policy.

As used within this application, a “beneficiary” is the person designated within a beneficial coverage contract to receive any payments or other benefits due under that contract. The beneficiary could be an individual policyholder or contract holder who contracts for the insurance or debt protection coverage in the form of, e.g., life insurance, supplemental disability insurance, homeowner's insurance, or automobile insurance; or a group of individuals who are covered by an employer policyholder's group insurance policy coverage in the form of, e.g., disability insurance, health insurance, dental insurance, or life insurance.

In the context of the present invention, “claimant” means the person who files the insurance or debt protection product claim for payment by the insurance company or loan term modification by the financial institution. In most cases, the claimant is the beneficiary under the beneficial coverage contract.

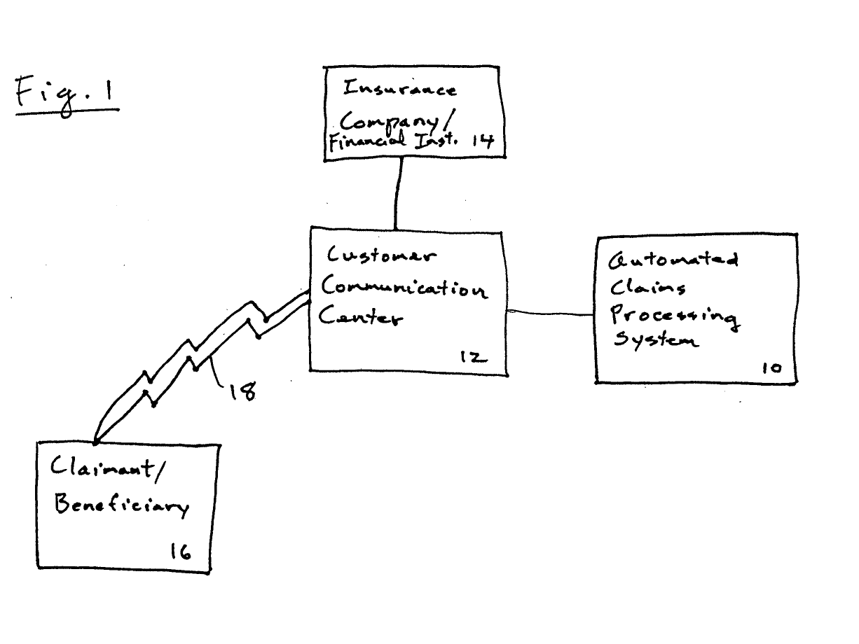

The automated claim processing system 10 of the present invention is shown in FIG. 1. A customer communication center 12 is operated by an insurance company or financial institution 14 for purposes of interacting with a claimant beneficiary 16 with respect to a claim submitted by the claimant under an insurance policy. The customer communication center 12 has an interface 18 for interacting with the claimant 16, which may comprise a claims representative available by telephone, fax, or mail. Alternatively, such interface 18 may enable the beneficiary to originate or follow up on a claim through self service via an Internet website or an IVR response system. Regardless of who initiates the claim, the claim processing system 10 operates in the same manner.

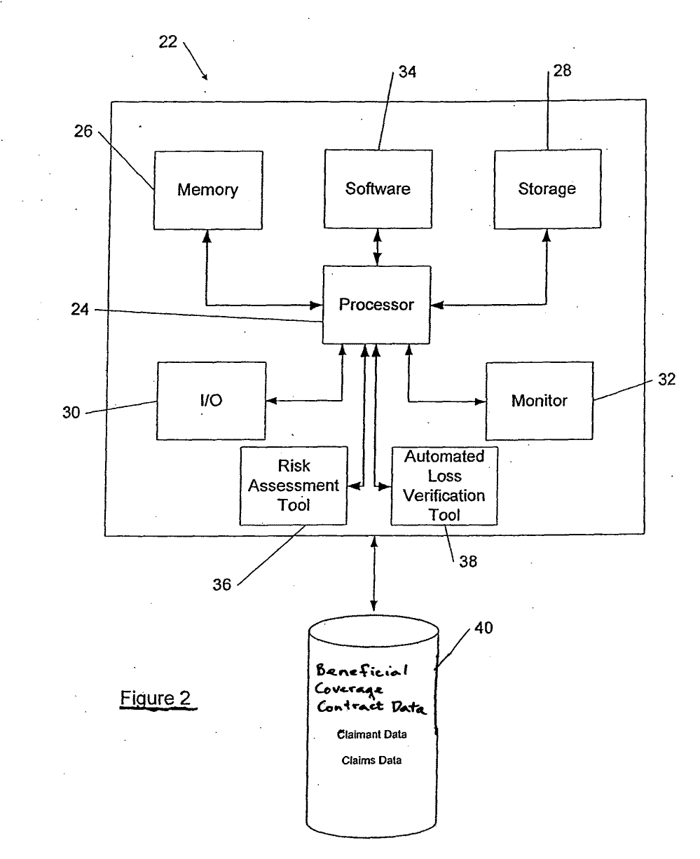

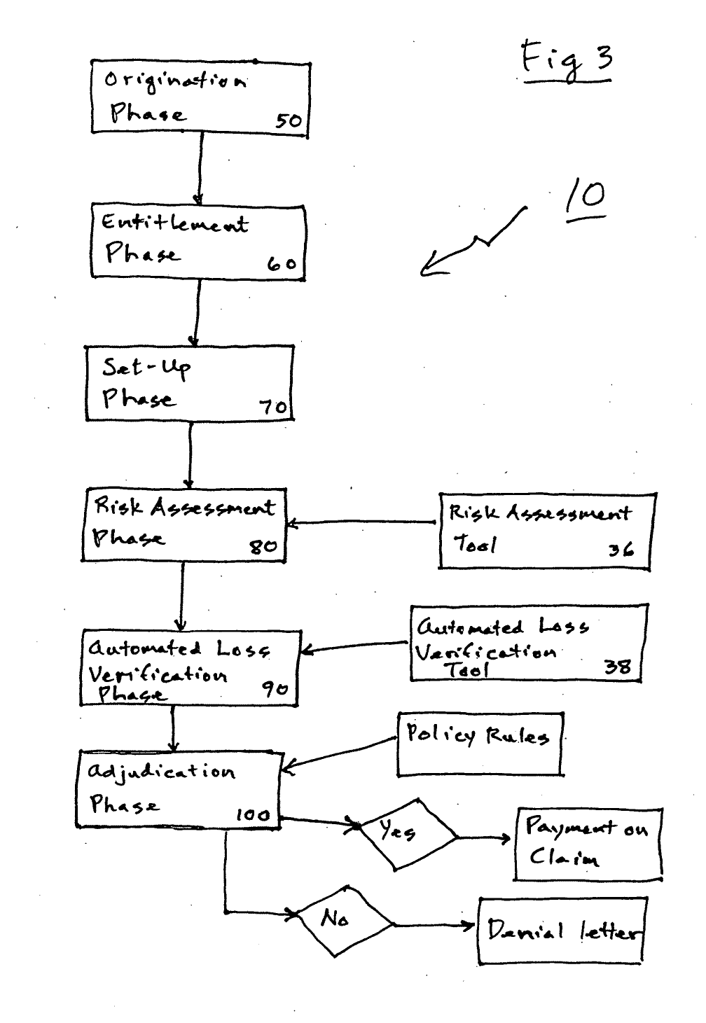

Referring to the example embodiment of FIG. 2, the automated claims processing system 10 comprises a general programmable computer 22 having a central processing unit (“CPU”) 24, controlling a memory unit 26, a storage unit 28, an input/output (“I/O”) control unit 30, and at least one monitor 32. Computer 22 operatively connects to database 40, containing, e.g., records of beneficial coverage contracts, claimant data, and claims data. It also operatively connects to the risk assessment tool 36 and automated loss verification tool 38 that will be described more fully herein. Computer 22 may also include clock circuitry, a data interface, a network controller, and an internal bus. One skilled in the art will recognize that other peripheral components such as printers, drives, keyboards, mousses, and the like can also be used in conjunction with the programmable computer 22. Additionally, one skilled in the art will recognize that the programmable computer 22 can utilize known hardware, software, and the like configurations of varying computer components to optimize the storage and manipulation of the data and other information contained within the automated claims processing system 10.

The software program 34 may be designed to be an expression of an organized set of instructions in a coded language. These instructions are programmed to facilitate the intake of claims information, assessment of the risk associated with that claim, and validation of the claim against fraud or error.

The computer system on which the system resides may be a standard PC, laptop, mainframe, handheld wireless device, or any automated data processing equipment capable of running software for monitoring the progress of the transplantable material. The CPU controls the computer system and is capable of running the system stored in memory. The memory may include, for example, internal memory such RAM and/or ROM, external memory such as CD-ROMs, DVDs, flash drives, or any currently existing or future data storage means. The clock circuit may include any type of circuitry capable of generating information indicating the present time and/or date. The clock circuitry may also be capable of being programmed to count down a predetermined or set amount of time.

The data interface allows for communication between one or more networks which may be a LAN (local area network), WAN (wide area network), or any type of network that links each party handling the claim. Different computer systems such as, for example, a laptop and a wireless device typically use different protocols (i.e., different languages). To allow the disparate devices to communicate, the data interface may include or interact with a data conversion program or device to exchange the data. The data interface may also allow disparate devices to communicate through a Public Switched Telephone Network (PSTN), the Internet, and private or semi-private networks. Referring to FIG. 2, automated claims processing system 10 includes a software program 34 having a plurality of graphic user interfaces (“GUIs”) that are displayed to a user in a text or graphical form to permit the input of data concerning the beneficial coverage contract holder, beneficial coverage contract loss event, and other facts underlying the claim. The GUI can also be used to display the status of the claim to insurance company or financial institution personnel, as well as the claimant customer.

The software program 34 can also produce and print a series of reports documenting this information. Finally, it will communicate the claims decision of the insurance company or financial institution to the claimant.

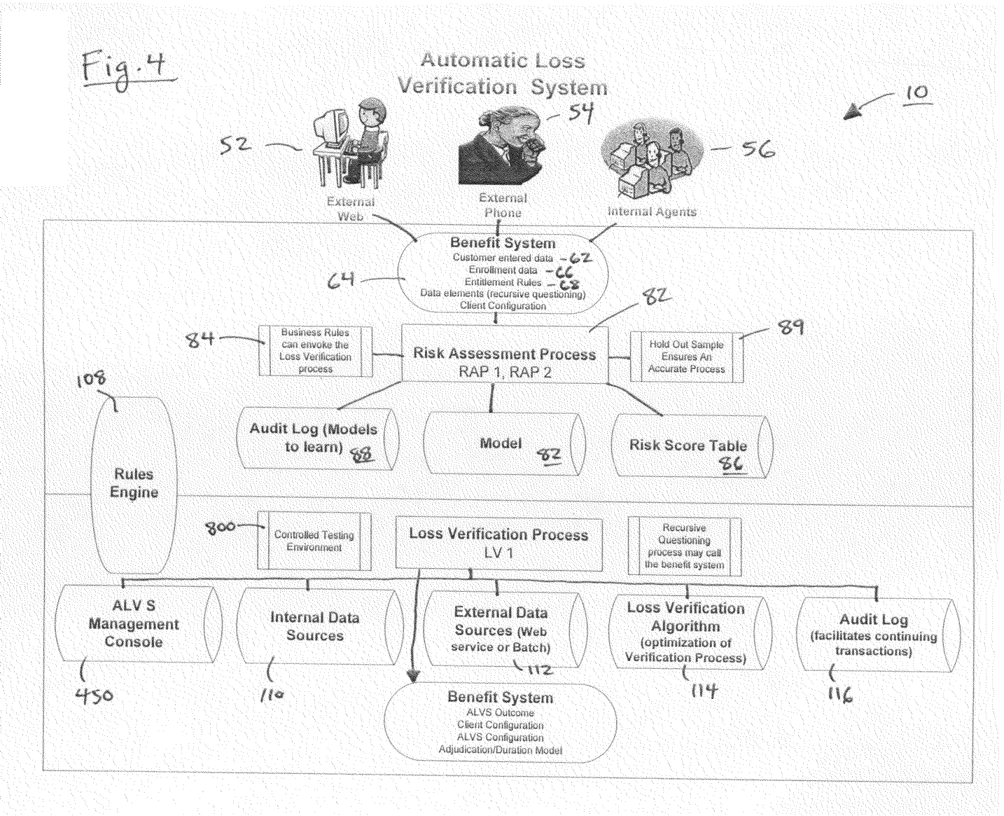

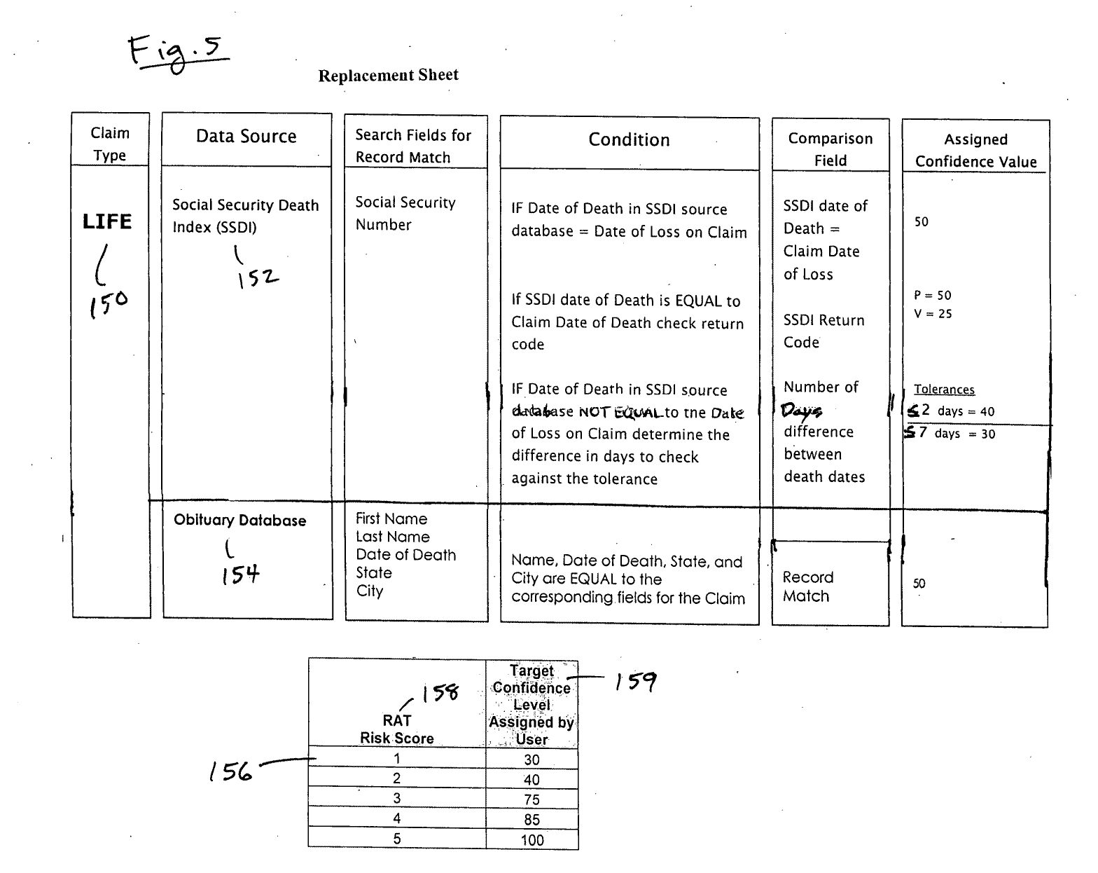

The automated claim processing system 10 of the present invention is shown in greater detail in FIGS. 3-4. In the “origination phase” 50, the claimant 16 can file a new claim, or check the status of an existing claim through communication via an external website 52 or IVR telephone input site 54 maintained by the operator of the automated claim processing system 10, or through a telephonic claims representative call center 56 of the operator. Once at the interface 18, the system 10 prompts the claimant 16 to select between filing a new claim/activation, requesting continued benefits, or checking the status of an existing claim/activation.

The system 10 will then proceed with requesting key data from the claimant 16 for the beneficial coverage contract. This key data for identifying the claimant includes one or more of the following: the claimant's last name and zip code, the account number for the beneficial coverage contract, the claimant's date of birth, and the activation/claim number. These data elements can be pre-selected by the system 10 based upon the product type (i.e., insurance policy or debt protection contract), product, claimant, or a combination thereof. Incomplete data will prevent the claimant from proceeding with the system 10.

Based upon this inputted data from the claimant 16, the claim processing system 10 determines whether it has an insurance company or financial institution record that matches the information entered. The data must match exactly the record information maintained by the insurance company or financial institution for security purposes. The system 10 may prompt the claimant 16 to maintain a password for the insurance policy or debt protection contract records as an added security precaution.

The system 10 then proceeds to the “entitlement phase” 60. During this phase, the system 10 takes the claimant-entered data 62 provided to the benefit system 64, and automatically compares it against enrollment data 66 and enrollment rules 68 stored within the system database to determine whether an applicable insurance policy or debt protection contract covering the beneficiary for the submitted loss event preexisted the claimed date of loss. During this entitlement phase 60, additional data elements are collected from the claimant to initiate the “setup phase” 70. It is during this entitlement phase 60 that the claimant 16 can also check his entitlement to continuing benefits under his insurance policy by entering his claim/activation number. The system will provide an answer based upon its stored entitlement rules 68 describing the terms of that insurance policy.

Next, the automated claim processing system 10 creates during the “set up phase” 70 a claims record defining the beneficial coverage contract and the relevant information describing the loss event forming the basis for the claim. This record will be evaluated by the system during the subsequent “risk assessment phase” 80 and “automated loss verification phase” 90 to automatically adjudicate the claim, as described herein.

For new claims, if coverage is not found, then the system 10 requests that the claimant 16 review the information entered and re-submit it. After a second unsuccessful attempt, the claimant is asked several questions regarding the policy or contract and type of coverage. Based on the information entered, the response will be as follows, depending on the medium used to interface 18 with the system (web, IVR, phone, etc.):
Web: the system provides the claimant a claims toll free number for further assistance. This toll free number bypasses the IVR and goes directly to a knowledgeable claims associate.
IVR: the system transfers the claimant to a knowledgeable claims associate.
Phone: the claims associate attempts to identify claimant coverage, requesting additional information.
Mail/Fax: the claims associate attempts to identify claimant coverage. If unsuccessful, forms are returned to the claimant with a letter and further instruction.

If coverage is found, then the system requests from the claimant the date of loss and displays all options covering the date of loss. The claimant selects loss type and moves on to the set up phase 70.

If several coverage records are found by the system that meet the loss type and date of loss, then the claimant is prompted to select which benefits he wants to activate/file a claim for. Once the selection is made by the claimant, then the entitlement phase 60 ends and the set up phase 70 begins. In this set up phase, all information required to establish a claim/activation record is gathered by the system and verified.

If several coverage records are found, but none meet the date of loss and/or loss type, then the claimant is advised of the coverage that he does have, with summarized, customer-friendly terms and conditions.

If coverage is found but the claimant does not qualify for benefits due to a waiting period or other requirement, then the claimant is advised of this fact and prompted to save the information entered. To save the information, the claimant must enter an email or street address. The system saves the information and emails/sends a letter to the claimant once the waiting period requirement has been met (based upon information entered during the entitlement phase). The claimant is given an origination number that will allow him access to the information entered, once the requirements are met.

The information should be maintained in the system 10 for up to 90 days after the requirement is met. If, after the 90 days, the claimant has not contacted the claims center 12, then a final notification is sent to the claimant, and at 120 days the information is deleted.

Once the claimant enters his existing claim/activation number, the system 10 displays the status of the claim. The claimant then verifies the information and proceeds to the “risk assessment” phase 80 of the automated claim processing system of the present invention.

During the set up phase 70, all information required to establish a claim activation record is gathered and verified by the system 10 prior to proceeding to the risk assessment phase 80, “automatic loss verification” phase 90, and “adjudication” phase 100. The claimant verifies information, such as the name of claimant/insured, address, phone number, email address, loss type selected, and date of loss entered during the entitlement phase 60. During this phase, the claimant is prompted to select the type of communication for the system sending its adjudication decision concerning payment on the filed claim. The default is email, but other options include mail and verbal communication.

If this selection of communication type is done through an IVR link, the system keeps a log of the selection and attaches it to the customer record. If this is done while on the phone with a claims associate, then the associate tapes the authorization. Taped authorizations are given a confirmation number that is attached to the claimant record so that it may be retrieved in the future.

Communication type “Verbal Only” means that the claimant accepts verbal notification and is turning off any web or paper communications that result from a phone call. This option only displays if the claimant is working with a claims associate via phone. When this option is selected, the claimant is giving the claims associate authorization to not send a “written” confirmation. If this communication type is selected, an additional one is required for non-telephone transactions—e.g., Web/IVR.

The claimant commits to the claim set up by clicking on a set-up confirmation button. At this time, the system 10 displays any restrictions associated with initiating the claim. Examples include:
Credit Card Usage Restrictions (the claimant cannot use the credit card during activation).
Waiting Period between activations (once the claim is approved, the claimant cannot file another claim until 30 days after last payment through the date of current claim).
   The claimant is given the opportunity to de-select any coverage records that he does not want to proceed with. The system 10 keeps a record under this transaction of the records selected and records not selected.

The claimant commits and the system 10 provides a pop-up screen asking him, “Are you sure you want to set up a claims record for the selected coverage records?” If the claimant selects “No,” then the process terminates and a record of the transaction is stored. If the claimant selects “Yes,” then the claimant is given an opportunity to set up security levels.

Based on claimant setup (not all claimants may choose to use this option), the claimant is given the opportunity to set up a security question/password. This password will be stored and be required for anyone to obtain information for this claimant account.

The claim processing system 10 shown in FIG. 4 includes a risk assessment process module 82 for conducting risk assessment phase 80 of the underlying process. Associated with risk assessment process module 82 is a model 84 for predicting the relative risk of the beneficial coverage claim being fraudulent or misstated. A set of business rules 84 stored within the system database is used by the system 10 to activate the risk assessment process module utilizing model 82. Also associated with risk assessment process 82 is a risk score table 86 that assigns a numerical risk assessment score to the beneficial coverage contract claim in response to the risk prediction output of model 82. Audit log 88 stores data for the real-world risk outcome of previous beneficial coverage contract claims similar to the claim in question. Using this information, the predictive model 82 can be modified by the operators of the system 10 to make it as accurate as possible.

In the risk assessment phase 80, the information entered during the origination, entitlement, and set-up phases are combined together with other information such as account balance, customer credit score, age, etc. to assess the relative risk of the claim being fraudulent, and assign a risk score. The risk assessment phase 80 of the claim processing system 10 utilizes a tool based upon advanced predictive modeling techniques for enabling the insurance company to assess the relative risk associated with a claim.

Statistical modeling utilizes data attributes of all insureds to develop an automated risk assessment tool (“RAT”) 36 (see FIG. 3) for assessing the risk associated with a particular claim. The resulting models (in FIG. 4) consider all possible trends among the variables to assess the claim and model the potential risk associated therewith.

Examples of different risk factors associated with an insurance claim are set forth in Table 1.

TABLE 1

| Dataflow Name | Exemplary Risk Factor Information |
|---|---|
| CDS Data | Outstanding account balance; how long has the |
| (Stored in Oracle) | policyholder been billed; the premium amount; |
| | did the policyholder just enroll; has the |
| | policyholder ever cancelled; has the |
| | policyholder been enrolled for a long time? |
| Demographic Data | Customer address. |
| Claims History | Has the policyholder ever filed a claim with the |
| (Stored in Oracle) | insurance company before; does the |
| | policyholder have other claims outstanding; |
| | what is the policyholder's current claims |
| | status; other claims variable data not herein |
| | listed. |
| Claimant Submitted Data | These are all the items that the claimant either |
| (Passed by Claims | enters into the web or the IVR or explains to |
| Portal) | the rep over the phone. These items are later |
| | used to arrive at a decision. Examples include: |
| | date of loss, type of loss, date of birth, last date |
| | of work etc. |

The RAT 36 model pre-scores the entire insured base on a periodic basis (e.g., daily, weekly, monthly). Each insured has multiple pre-scores at the product/coverage level. The pre-scores are stored in the oracle data warehouse maintained by system 10.

As a specific insurance claim comes in, the information entered during the origination, entitlement and set-up phases 50, 60, and 70 are combined with the information used in the pre-scoring process to re-score each individual claim in real time. Note that requests for continuing benefits, by contrast, go through different RAT models tailored to continuing claims only.

In doing so, claimants can be ranked by risk profile from highest to lowest. These claimants can then be grouped by risk category. Using those categories, insurers and lenders can determine the extent to which a validation step should be applied to a particular claim as part of the adjudication process. The decision of what source to use is also model-driven, where the confidence level for each data source is determined using a variety of statistical modeling techniques. For example, in the death claim illustrations discussed previously, those two claims might receive either a high or low risk associated with the claim. In the case of the death involving the 80-year-old insured, the model might profile the risk as low. In the case of the $100,000 claim, the model may categorize the claim as high. In response to these categories, the insurance company may decide to approve the lower risk claim early in the process with validation techniques providing a lower level of confidence. Additionally, the insurance company may chose to approve the higher risk claim only after receiving more information for loss validation, which provides a higher level of confidence. For example, in the first case the insurance company may accept an obituary as proof of death for approval. In the second case, the insurance company may require a death certificate from the state as proof of claim for approval.

The RAT 36 will preferably include a look-up table that can be utilized by the computer 22 underlying the system 10, or by a beneficial coverage contract company employee who manually conducts the claim validation exercise. Such look-up table might adopt the form of Table 2 in which the relative risk level for a claim is translated into an approximate level of confidence (i.e., proof) that is required by the insurance company or financial institution to approve the claim, given the level of risk associated with that claim.

TABLE 2

| Risk Level | Confidence Level |
|---|---|
| 0 (Very low) | 0% |
| 1 (Low) | 40% |
| 2 | 60% |
| 3 | 80% |
| 4 (High) | 100% |

Thus, a score of “4” determines that the transaction is high risk and may require validation via a data source, which has been determined to provide 100% confidence, or in combination of sources which collectively provide 100% confidence, in the form of full documentation before a payment or deferment is granted. By contrast, a low score of “1” may yield less documentation requirement. A very low score of “0” may prompt no required validation through a data source for approval.

It is important for the validity of the automated claim processing system 10 of the present invention that the advanced predictive models underlying the RAT tool 36 and associated model 82 be checked periodically against actual results for the validity of claims filed by claimant. Hence, data sources are controlled, monitored and validated by a random hold out sample 89 of claimants who file a claim. The hold out sample 89 is randomly generated by selecting every nth customer. The hold out sample 89 is scored by the RAT tool 36 and verified by one or more of the automated loss verification (“ALV”) data sources—preferably by all the available data sources if maximum confidence that the system 10 is working is desired. The system will compare the result of each data source verification against the result of the claimant-provided loss verification in order to determine that the ALV system models are working properly. Certain trends such as customers who never provided loss verification (self-denial) will be analyzed and followed up upon to determine if any changes need to be made to the data source (example: adjusting the confidence level).

It is possible that the insurance company or financial institution may not require validation for a claim having a very low risk level (e.g., risk level “0”), because either it appears to be valid on its face, or else the amount of the claim in question is too low to warrant the cost of the validation process. In such case, the claim processing system 10 will be structured to send this claim directly to the adjudication phase 100 (see FIG. 3) for communicating an affirmative decision for payment to the claimant.

The parameters for the RAT models and table-driven values are maintained in a management console. This management console allows for the change/adjustment of scoring data elements, coefficients, data sources, and confidence levels. Testing of hypothesis is done within a controlled environment using the management console. The ability to test theories is allowed at the management level. Reporting in common business language is developed so users can make decisions based upon testing.

In the case where the look-up table has dictated some measure of required confidence level above 0% for the claim under the risk assessment phase 80, then the system will proceed to the automated loss verification phase 90. Automated loss verification or “ALV” is a table-driven tool 38 that is connected to various data sources, depending upon the loss type. It is the job of the ALV tool to automate the verification process by assigning a confidence level requirement based upon the risk score and the product, product type, client, and/or state (any combination of). Then, based upon the confidence level requirement specified for the claim, a separate look-up table identifies the independent data source or combination of independent data sources required to validate the claim based upon its risk score. Table 3 illustrates such a look-up table.

TABLE 3

| Required Confidence Level for Claim | Independent Data |
|---|---|
| Approval | Source Combination |
| 0% | None |
| 40% | A |
| 60% | A, B |
| 80% | A, B, C |
| 100% | A, B, C, D |

Alternatively, an algorithm or base logic stored in the software 34 can dictate the order of data sources used by the system. Each of these specified independent data sources will then be consulted automatically by the system 10 in turn to verify the claimed loss.

An exemplary list of independent third party sources available for validating a claim, and the relative confidence level attributed to each source is shown in Table 4.

TABLE 4

| Data Source | Use |
|---|---|
| Medispan | Verify that a customer is taking |
| Drug indications Database | medication for a specific condition. |
| Dr. 411 | Confirm a customer's physician and |
| Doctor Database | practice; potentially contact a |
| | physician. |
| Intelliscript Prescription | Verify that a customer is taking a |
| Database | specific medication by accessing |
| Milliman Co. | his/her prescription history. |
| Medical Disability Advisor | Determine benefit periods for |
| Official Disability Guidelines | disability and/or unemployment |
| Reed Group | claims. |
| Claims Activity Index | Access customer information for |
| Medical Information Bureau | validation of claims. |
| Ingenix | Verify that a customer is taking a |
| | specific medication by accessing |
| | his/her prescription history. |
| Scriptcheck | Verify that a customer is taking a |
| | specific medication by accessing |
| | his/her prescription history. |
| Obituary Registry.com | Search for deceased's obituary to |
| | verify death. |
| State Unemployment offices | Verify unemployment status. |
| State Disability offices | Verify if permanent disability status |
| | has been granted. |
| Trusted Partners | Accepting verification from |
| | insurance company's partners (this |
| | is not limited to clients). |

The ALV table, algorithm, or base logic-driven tool 38 is connected to various data sources, depending upon the loss type. It is the job of the ALV tool to automate the verification process by assigning a confidence level requirement to the claim, based upon the risk score and the insurance product, product type, client, and/or state, or any combination thereof. The ALV tool has the ability to retrieve information from the different data sources and accumulate points/confidence levels, based upon the information obtained from each of the data sources. Based upon the confidence level requirement for the claim, each of the data sources necessary to attain the confidence level is queried to automatically verify the loss. Some data sources have different confidence levels based on the type of verification that can be obtained from them. For example, in the case of the SSDI, a death confirmation of P may yield a confidence level of 100%, whereas a death confirmation of V may yield only a 50% score. Each data source ties to one or many loss types and may have different confidence scores depending upon the product type, product, client, state, loss type and/or any combination, based upon setup at the ALV level.

In a preferred embodiment of the automated loss verification tool of the present invention, the system assigns a required target confidence level (“TCL”) for validating a particular beneficial coverage contract claim corresponding to the assigned risk score for that claim. Note that just as the risk score can be set by the insurance company or financial institution that granted the insurance policy or debt protection contract in accordance with its claims experience and underwriting policies, the insurance company or financial institution can select its own required TCL based upon its accepted appetite for risk. One insurance company or financial institution may accept a higher degree of risk for potentially fraudulent or otherwise inaccurate claims, and therefore require a lower TCL to validate a claim under this automated loss verification tool. This lower TCL value will enable it to reduce the administrative costs associated with the claims validation process utilizing the automated loss verification tool of the present invention. By contrast, another insurance company or financial institution may require a higher TCL value in order to validate the claim due to its diminished level of accepted risk. This will result in a greater combination of corroborating data source references used to validate the claim using the automated loss verification tool.

Each of the corroborating data sources has assigned to it a contributory validation score proportionate to its relative degree of confidence for establishing the veracity of the claim. For example, customer-provided information concerning the death of a life insurance policyholder might only be characterized by a 40% degree of confidence, while a newspaper obituary might provide a 60% degree of confidence. The newspaper is an independent source, logically entitled to more creditability for veracity than the claimant, himself. However, newspaper writers have been known to make mistakes. A listing of the deceased in the Social Security Death Index, on the other hand, might be entitled to an 80% confidence level score due to the documentary verification process employed by the Social Security Administration to verify a death before it commences payment of benefits. Finally, a certified death certificate issued by the local government will establish the fact of the death with a 100% degree of confidence.

Note that the insurance company or financial institution can determine its own confidence score that it assigns to each corroborating data source in accordance with its own claims validation experience and risk tolerance profile.

The system of the present invention performs the following iterative calculations for purposes of utilizing the available corroborating data sources to validate a claim:

| | |
|---|---|
| Accumulated Verification Value | Σ values of Data Sources checked |
| (“AVV”) = | for the claim. |
| Remaining Verification Value | (TCL - AVV) required for the claim. |
| (“RVV”) = | |
| Possible Verification Value | Σ values of unchecked available |
| (“PVV”) = | Data Sources for the claim. |
| Maximum Verification Value | Σ values of all available Data |
| (“MVV”) = | Sources for the claim at beginning |
| | of automated loss verification |
| | process. |
| Running Possible Verification | Σ all PVVs (hit or no hit) for each |
| Value (“RPVV”) = | pass: RPVV = PVV |

The ALV process for continuing claims will only be initiated if the provisional period for the corresponding product/client has been exceeded. If the corresponding benefit period is still active, then the ALV process should not be utilized. Instead, the claims process should proceed directly to the adjudication phase. If proof of loss under the beneficial coverage contract has been provided by the claimant, then the ALV process likewise should be bypassed. Finally, the claim must have passed the Entitlement Phase prior to initiating the ALV process.

A number of specific rules are applied to the administration of the ALV process. First, a corroborating data source, which may be an internal database maintained by the operator of the ALV system, or else an externally sourced database, will only be accessed if the TCL is attainable and it has been assigned as a source of validation for the corresponding line of business (product/client component). Thus, MVV≧TCL.

Second, a corroborating data source will only be used once during the adjudication of a claim unless otherwise indicated as a date-related validation source, or if a previous attempt to search a database failed to produce a match.

Third, the confidence score of each corroborating data source successively searched with a match for the claim will be added to the AVV, so that the AVV score represents the current, cumulative validation score for that claim.

Fourth, after each corroborating data source search, the AVV score is compared against the required TCL value for that claim to determine whether the TCL score has been achieved yet for that claim. If the TCL score has been achieved, then the ALV process is completed and the claims processing system 10 proceeds to the Adjudication Phase 100 for the claim. If the TCL score has not yet been satisfied for the claim, then the ALV process should only continue with the consultation of the remaining corroborating data sources available for the claim if the RVV value for the claim (TCL−AVV) is attainable by the PVV of the remaining, unchecked corroborating data sources. If the PVV value of those remaining, unchecked corroborating data sources does not exceed the RVV score for the claim, then the ALV process concludes, and the claims processing system 10 should proceed to customer provided loss verification of the claim before the adjudication Phase 100 is reached.

### Example 1

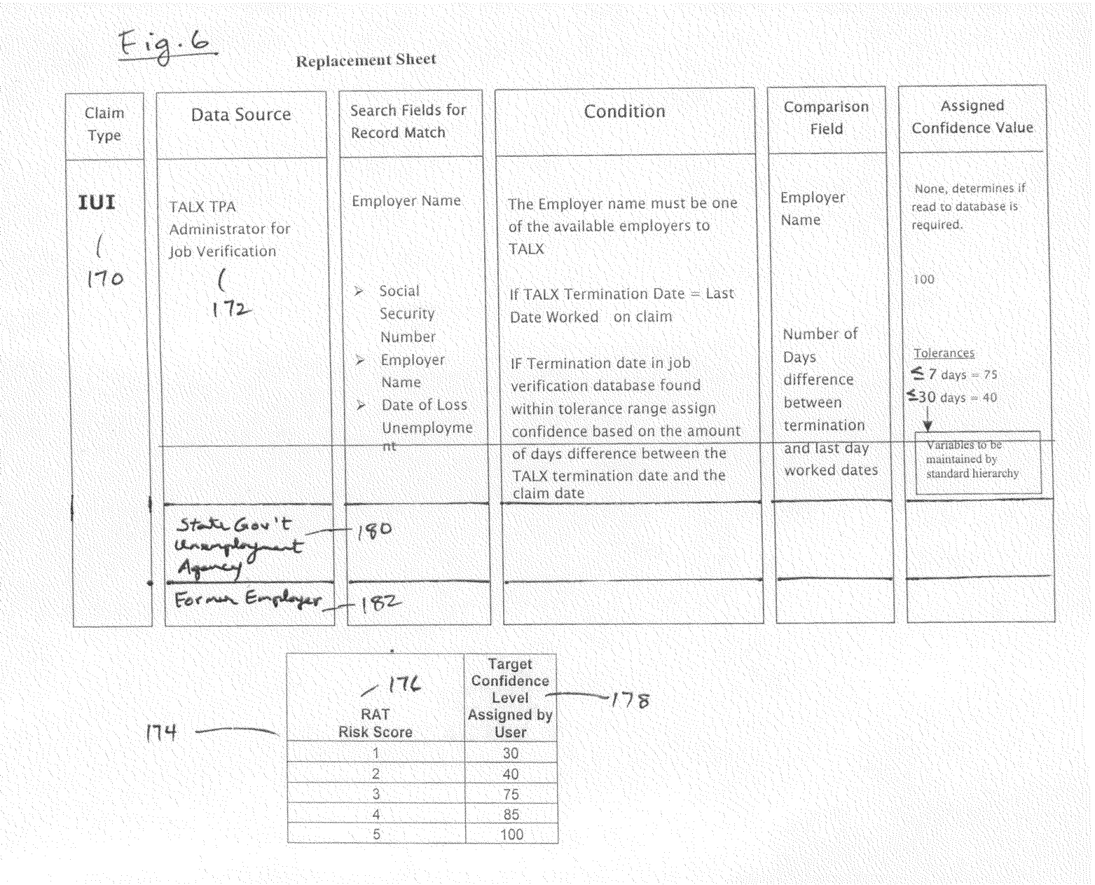

An example of the application of the ALV process tool of the present invention to a life insurance policy claim is shown in FIG. 5. For the life insurance policy claim 150, the ALV process has pre-assigned two corroborating data sources: the Social Security Death Index (“SSDI”) 152 administered by the Federal Social Security Administration, and an obituary index 154.

The rules engine of the ALV process tool contains a TCL conversion table 156 pre-established by the insurance company that issued the life insurance policy. This table indicates that for a life insurance policy of the type that is the subject of the benefit claim, a risk assessment score (“RAS”) 158 of 1 translates to a required TCL score 159 of 30% for validating a claimed loss. A RAS of 2, on the other hand, requires a TCL score of 40%. The corresponding RAS values of 3, 4, and 5 translate into required TCL scores of 75%, 85%, and 100%, respectively, under the exemplary ALV process.

In accordance with the rules engine, the ALV process first consults the SSDI, which is accessible online. If there is a match between the decedent's social security number and date of death supplied by the claimant and the SSDI record, then the pre-assigned confidence value 50 is added to the AVV score as a result of this data match. Thus, AVV=50% for the automated claim validation process. In this case, claims with a RAS score of 1 or 2 and resulting TCL requirement of 30% or 40% would be verified, because AVV≧TCL. Such claims would move on to the adjudication phase.

For claims with a RAS score of 3, 4, or 5 corresponding to a TCL score of 75%, 85%, or 100%, respectively, however, the ALV process must proceed. In this case, the SSDI Return Code of the SSDI reference is consulted. If the Return Code has a “P” value, meaning that proof of the deceased's death in the form of a death certificate was already provided to the Social Security Administration, then an additional pre-assigned confidence value of 50% would be added to the AVV score, so AVV=100%. In this case, all claims having a RAS value of 3, 4, or 5 would be verified. If, by contrast, the death of the deceased was only telephoned into the Social Security Administration without proof of a death certificate, then the SSDI Return Code will be “V,” in which case, an additional pre-assigned confidence value of 25% will be added to the AVV score, so AVV=75%. In that event, a claim having a RAS value of 3 would be verified, but additional proof would be required for a claim having a RAS value of 4 or 5.

If the SSDI record provided a match for the deceased's social security number reported by the claimant, but not the date of death, then the ALV process proceeds to a determination of the difference between the SSDI date of death and the date of death reported in the claim. If this difference is ≦2 days, then AVV=40% for the claim. In this case, claims having a RAS score of 1 or 2 would be verified, while those with RAS scores of 3, 4, or 5 would not. If, on the other hand, the difference between the reported and claimed dates of death is less than 7 days, then the AVV value contributed by the SSDI reference would only be 30%, so only a claim having a RAS value of 1 would be verified.

For any claims not successfully verified by the SSDI record, the ALV process will proceed to consulting an obituary database 154. If a matching obituary record for the deceased is found with the same name, death date, state, and city compared with the information found in the claim, then an additional 50% is added to the AVV score for the claim. If the RVV for an unverified claim was ≦50% after use of the SSDI records, then such claims will be verified by a successful obituary database match.

### Example 2

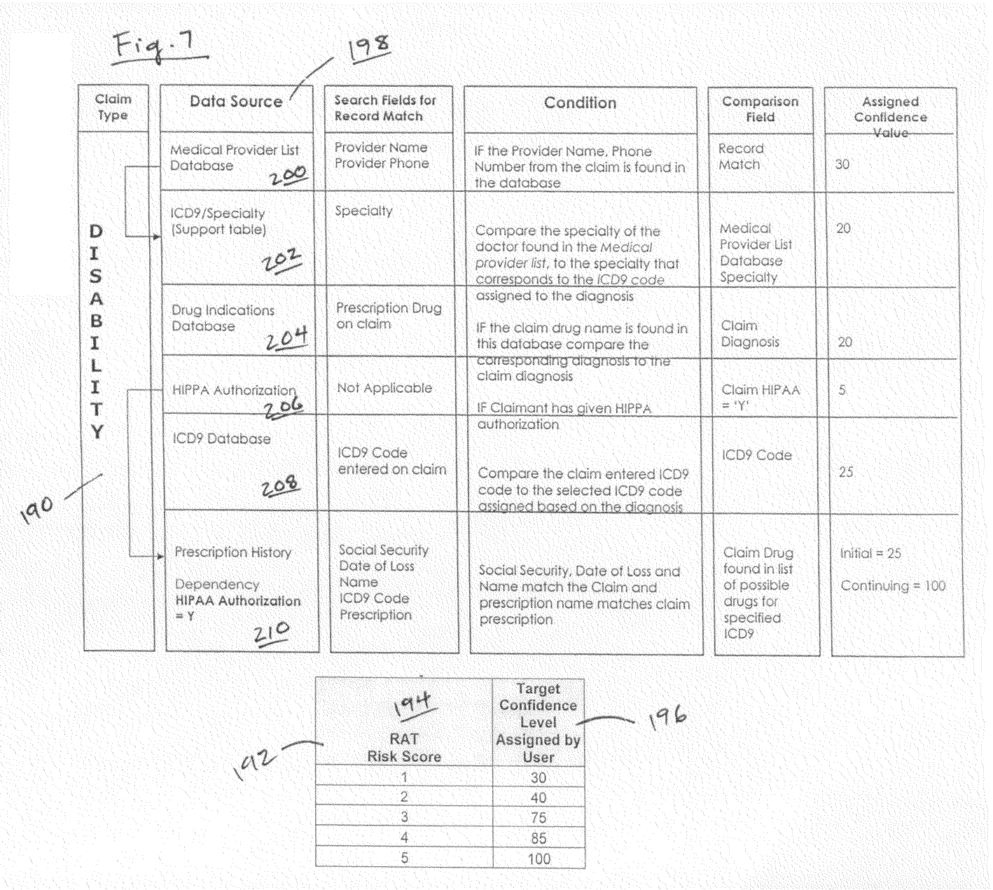

FIG. 6 provides an example of application of the ALV process of the present invention to an involuntary unemployment insurance (“IUI”) claim. The rules engine has pre-assigned the TALX TPA Job Verification Database 172 as a corroborating data source for verifying an IUI claim. This database will be accessed by all customers filing an unemployment claim. Not all employers are part of this database, so the ALV process first checks the TALX TPA Job Verification for the employer's name. A match contributes no confidence level to the AVV for the claim, but instead allows the ALV process to proceed.

Next, the ALV process checks the TALX TPA database for the unemployed person's name, social security number, and date of termination. If this information in the database record matches the information supplied by the claimant, then the ALV process contributes 100% confidence value to the AVV score for the claim. In this case, the claim, regardless of its RAS score 176, would be verified because its AVV≧TCL score 178.

If the termination date reported within the TALX TPA database does not match the termination date provided by the claimant, then the difference between these dates must be calculated under the ALV process. If this difference does not exceed 7 days, then a confidence value of 75% will be contributed to the AVV. Such an AVV score would verify all IUI claims having a RAS score of 1, 2, or 3. IUI claims having a risk score of 4 or 5, by contrast, would require additional corroborating data source proof, which could be in the form of state government unemployment 180 or verification information provided directly by the former employer 182. If the difference exceeds 7 days but is less than 30 days, then only 40% confidence value will be contributed to the AVV score for the claim.

### Example 3

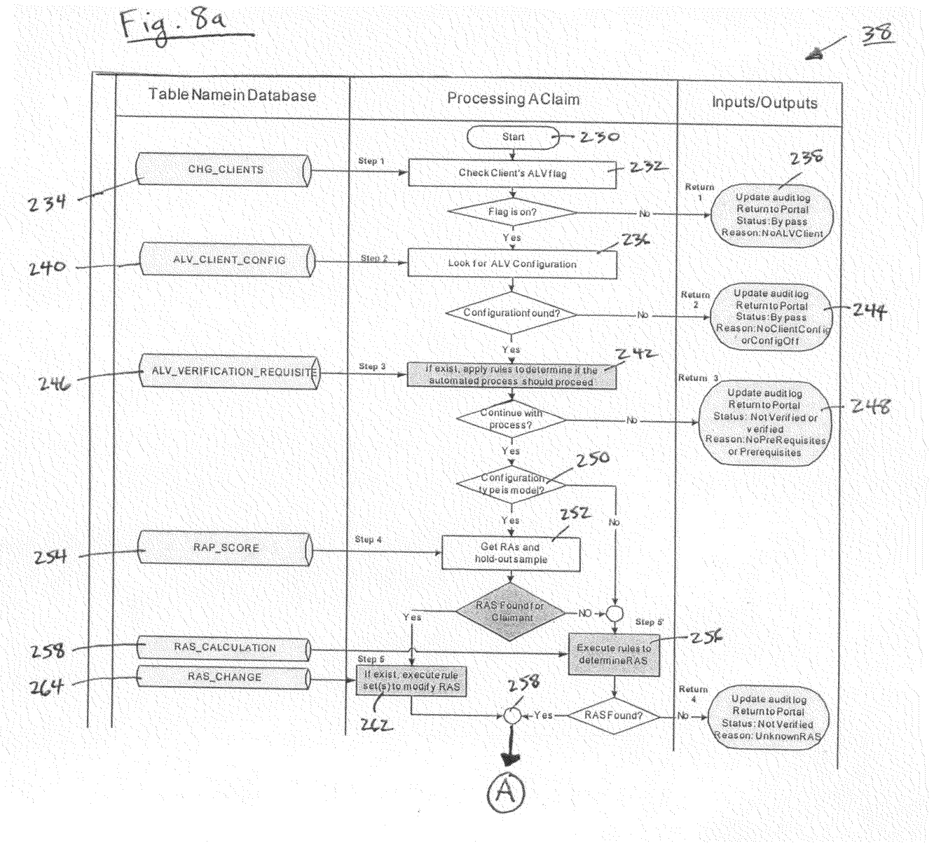

FIG. 7 provides an example of application of the ALV process of the present invention to a disability insurance policy claim. The disability insurance policy claim 190 has associated with it a look-up table 192 containing predetermined RAS scores 194 and associated TCL values 196. A variety of corroborating data sources 198 is also presented by the insurance company for purposes of verifying a disability insurance policy under the ALV process.

For example, Medical Provider List database 200 can be accessed for doctors and other medical services providers supplying services to a patient. If a name and telephone number for the medical services provider matches the information supplied by the claimant, then a 30% confidence level is contributed to the AVV score for the claim. In this case, a claim having a RAS score of 1 will be verified, while claims having a RAS score of 2-5 require additional corroborating source proof of their veracity.

The ICD9 Diagnosis/Specialty database 202 contains a list of medical service specialties and typical diagnoses associated with that specialty. A successful match of the diagnosis supplied by the disability insurance claim with the specialty of the medical service provider already verified by the Medical Provider List database 200 will contribute 20% confidence value, so that AVV=50%. This will verify a disability insurance having a RAS score of 2.

The ALV process will then proceed to query Drug Indications Database 204. This database contains a list of drug names and the medical diagnosis for which they are typically prescribed. If a match between the drug prescription and medical diagnosis information supplied by the claimant is found within the Drug Indications database, then 20% confidence value is added to the AVV score for the claim. In this case, the resulting 70% AVV score will not verify claim with a RAS score of 3-5.

Claimant's authorization (206) under HIPAA for the insurance company to verify medical records provides an additional 5% confidence value is contributed by this particular corroborating data source. Now the AVV score for the claim is 75%. This validates a disability insurance claim having a RAS score of 3, but not those having a RAS score of 4-5.

The ICD9 Database 208 contains a listing of ICD9 codes assigned to their corresponding diagnosis. Should this database match the ICD9 code supplied within the claim, then 25% confidence value is contributed to the ACC score for the claim. In this case, the resulting 100% AVV score would verify all claims having a RAS score of 4-5. Note, however, that if a match with the Medical Provider List Database 200 for the medical service specialist's name was not found, then the ICD9 Specialty Database 202 could not contribute confidence points either. In that case, successful matches using this Drug Indications Database 204, HIPAA authorization consent 206, and ICD9 Database would only provide a total AVV value of 50%, so only RAS 1-2 claims would be verified.

The Prescription History Database 210 contains a list of drugs prescribed to a particular patient. If the social security number, date of loss, and name records within the Prescription History database 210 match information in the claim, and the prescription name matches the prescription identified within the claim, then usage of this particular corroborating data source suppliers 25% confidence value to an initial disability insurance policy claim, and 100% to a continuing claim. This may be enough to produce an AVV score that exceeds the required TCL score for the claim.

Therefore, the calculation for RVV and PVV will be recalculated recursively for a claim after each corroborating data source is used in the ALV validation process 38. This process determines if the required TCL value for the claim has been achieved to validate the claim, or whether the ALV process needs to continue to query another corroborating data source in which case any additional data required from the claimant is identified.

Because the cost of the third-party data sources does impact the economics of the system 10, it is important to utilize the most cost-effective source or combination of sources that provides the necessary confidence level to the claims adjudication decision-making process. The automated loss verification tool 90 of the present invention consults each of the independent data sources in succession from lowest confidence level to highest confidence level. Thus, if the customer-provided loss information corroborates the claim to satisfy the required confidence level, then the system proceeds to the decision point pursuant to the adjudication phase 100. If the required confidence level is not met, then the system will proceed to search for successive corroborating data sources until AVV≧TCL for the claim. Depending upon the risk of the claim, the system may have set a very high confidence level that can only be satisfied by two or more of the independent data sources in combination.

If the confidence level required is attained, the ALV phase 90 is complete and the claim/activation moves on to the adjudication phase 100. If the confidence level is not attained, the ALV phase 90 is complete, the confidence level required and confidence level attained is recorded, and the claim/activation moves to a customer-provided proof of loss process.

Thus, unlike prior art claim processing systems used within the industry where the insurance companies and financial institutions typically burden the customer with the task of providing the required information to validate the event, the system 10 of the present invention saves the claimant in most cases from this burden. For example, under the prior art approach, a beneficiary filing a death claim is asked to provide the insurance company with the death certificate prior to claim approval. An insured filing a disability claim is required to provide a form signed by a doctor validating their disability and inability to work. This step to provide proof costs the customer both time and money. Additionally, it costs the insurance company resources to document the request for information, follow-up on the request, process the information received, and retain the information for future reference. It also adds to the cycle time needed to fulfill the benefit back to the customer.

Asking the claimant for proof of loss is a non-standard, less-preferred loss verification method under the present invention. Claims/activations that do not qualify for automated loss verification due to risk/confidence levels not being met, or due to client/product/state requirements will trigger this requirement.

The claimant is prompted to complete certain information and/or attach documentation required (web). For example, an Attending Physician's Statement (APS) may be required. If an Attending Physician Statement (APS) or other form is required, the customer is prompted to print the document or request that it be mailed all documentation printed (via web) or mailed is bar-coded, to tie to the appropriate claim record.

Any documentation attached (web only) is sent to the appropriate examiner work queue for examiner review and adjudication. The claimant is informed that the documentation has been forwarded for review and that a notification will be sent (via email or post office mail), within 5 to 10 business days (the number of days that is displayed is dependent on the client setup). At this point the claimant is reminded of the communication method selected and is given the opportunity to update or change the information provided. In this phase the claimant is also reminded to continue to make payments until the claim/activation has been approved (or any other script requirement based on client setup). If no documentation is attached, the claimant will receive email/mail notification of the pending documentation periodically, based upon product, client, state, etc. table entries that drive correspondence.

Note that in some cases, verbal verification provided by the claimant may act as a sufficient corroborative data source for purposes of validating the claimed loss event. This most often will occur in the event of a very low-risk claim where the relative risk of a fraudulent or erroneous claim or factual recitation provided by the claimant simply does not justify the costs and customer inconvenience associated with further inquiry, including under the ALV process and system of this invention.

The preceding description of the ALV system of the present invention has focused upon a two-step process: (1) Use of the RAT to assign a risk assessment score to the claimed loss and selection of a TCL value that must be achieved to verify the validity of the claimed loss; and (2) iterative selection of one or more corroborative data sources that contribute predetermined confidence scores towards achievement of the TCL value as they are hit by the system to successfully verify the claimed loss. In a preferred embodiment of the present invention, a one-step ALV system model is produced using analytics. In this embodiment, all of the data characterizing the claimant, claimed loss event, and the available corroborative data sources are combined to produce a model through statistical techniques that provides a single, overall score that represents the confidence level associated with approving the claim with the elected validation source(s). This system works to find the combination of claim and corroborative data source(s) that provide the minimum threshold established in the system. The cost associated with the data source should be considered within the model in order to optimize the costs of operating the ALV process.

Following the automatic or customer loss information-provided verification process, a decision is rendered based upon the verification received and the rules established by product, client, state under the adjudication phase 100 (and state exceptions), etc. and or any combination of these. It is in this adjudication phase that benefit duration (if applicable) and payment amount is determined and disclosed to the claimant.

For continuing benefits, the automated benefit duration model houses rules that determine the duration of approval for the claims benefit once approval of the claim has been granted. A number of factors are addressed by such rules, including medical diagnosis, employment type, and state of residence (e.g., known unemployment events, natural disasters). In this manner, claimed benefits duration can be tied to the claimant's specific loss condition, instead of more generalized, one-size-fits-all rules.

If the claim/activation is approved, the claimant sees all the information pertaining to the approval. For example, a payment or deferment amount or if amount is not available, monthly or a simple “replacement of your property has been approved” statement. The details that display are driven by table entries in the rules engine.

Depending upon the client/product setup, the system's automated model determines:
Where/how to retrieve information required (automated data retrieval vs. request billing statement)
The appropriate payment calculation method
Any applicable interest due
Any additional benefits (i.e., additional accidental death benefits based upon life insurance policy)
If the type of claim has an associated duration model

Billing statement data is automatically retrieved to make a payment amount decision, based upon client setup. Several methods are available: Connectivity to client's data; data feeds from client to the claims center utilizing loop process; etc. The system may also seek the billing statement data from the financial institution upon demand. If the billing statement information is not available automatically, there is a semi-automated process and a less preferred, manual process to determine the benefit/payment amount. The user is advised of future notification, and the semi-automated or manual process begins.

Insurance companies and financial institutions log into a web tool that shows claims/activations where billing statement information is required to determine a benefit/payment amount. The insurance company or financial institution enters the information needed and transmits the required data to the claimant communications center 12, where the system automatically determines the benefit/payment amount and notifies claimant.

The claimant (web) may choose to attach a copy of the billing statement. If the claimant is filing a claim/activation through the IVR, they are advised that they may mail or email required documentation via the web.

Less preferably, the system's operator will seek billing statement attachments directly from the claimant. The billing statement attachments are sent to the appropriate examiner work queue for determination of the benefits/payment amount. Notification of payment/benefit amount will be sent (via email or post office mail), preferably within two business days, or the number of days defined by the client setup within the ALV system.

When customer-provided loss verification process is necessary, examiners use a step-by-step document review process. The system specifies the acceptable documentation requirements for each insurance product in terms of its client, benefit structure, etc. As the examiner reviews the documentation the system asks or walks the examiner through the process.

For example, on an Accidental Death Claim, a Certified Death Certificate (CDC) is needed. The system will prompt the examiner as follows:
Do you have a CDC?
Is cause of death accidental?
What was the date of loss?
Was it for the primary card holder?
   As the Examiner enters/selects the response, the decision-making process is completed.

Every decision is tied to verbiage that is communicated to the claimant via the claimant selected communication method—web, email, IVR, letter, claims associate script. Requests for additional documentation list all required documentation; denials list all reasons for denial; and approvals provide specific details as to payment date, method, and what to expect next. This module housing all of the verbiage is table-driven and user-maintained. It allows insurance companies and financial institutions to set up verbiage by product/claimant/benefit/state, etc. Examiners can view and approve or revise verbiage prior to release to the claimant (if the process is driven by AIZ).

In this phase, if payment is owed, the claimant then selects the payment method (check, ACH, etc). Payment methods will be stored on tables and displayed based on client/product setup. Once the user selects the payment method, the system will advise as to the expected date of payment delivery, based on method selected and client/product setup.

Once payment selection is made, the claimant is prompted to save information (AIZ/web user) or print (web). The claimant is reminded of their claim/activation number and is provided with an 800# (or web address for Internet users). At this point, the session ends.

If the claim/activation is denied, the denial reason is displayed, based upon product, client, state, etc. rules. Once denied, the claimant has the option to view terms and conditions or have a copy mailed/emailed to their address of choice. A claims toll free number can also be provided at this stage (web). Record of denial is maintained as well as record of claimant notification—the claimant can select to receive written communication or not. At this point, the session ends. All decision scripts are table-driven. What the claimant sees or hears is dependent upon the client/product/state setup.

Therefore, in accordance with the automated claim processing system 10 of the present invention, claims can be reviewed quickly and efficiently without burdening in most cases the claimant with the need to fill out detailed claims forms and obtain and supply corroborating documentation to prove the covered event. By obtaining such evidentiary documentation from available third-party or proprietary sources, the insurance company or financial institution can adjudicate the claim consistent with its accepted risk level, while saving administrative cost and reducing the examination and adjudication time period from a month or more to a short time duration. For purposes of this invention, “short time duration” means two days, preferably two hours, even more preferably within real time while the claimant is on the telephone with the insurance company or financial institution customer service representative, or connected to the website or IVR portal benefits activation system. Moreover, the claimant will inevitably appreciate the streamlined claims processing system as exemplary customer service.

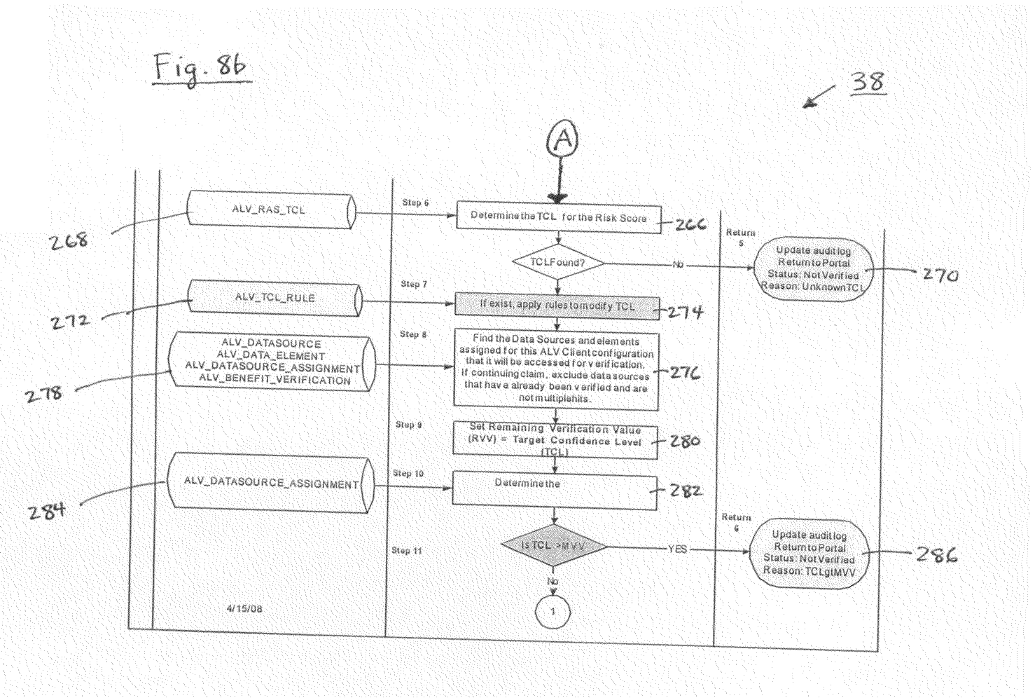

The architecture of the ALV process portion 38 of the claims processing system 10 is depicted in FIGS. 8-10. Once a beneficial coverage contract claim proceeds through its Origination Phase 50, Entitlement Phase 60, Set-Up Phase 70, and Risk Assessment Phase 80, it reaches the starting point 230 of the ALV system 38. In step 1, the system checks the status 232 of the client's ALV flag. A database 234 stores a list of all the different insurance company and financial institution clients serviced by the claim processing system 10 and automated verification system 38 of the present systems in the case where a company operates a system servicing the claims of multiple clients. If the client's flag has been set to the “on” position, then the ALV system proceeds to the ALV configuration step 234 of Step 2. If the ALV flag has not been set, then the system updates the audit log database 238 to reflect this fact, and then proceeds to a customer-provided loss verification of the beneficial coverage contract claim. Database 240 stores data for each client's specific configuration of the ALV system 38. Such data should include whether or not the ALV system should be used to verify a claimed loss, the parameters for claims to be covered by the ALV system, how frequently to test the ALV system, the rules or algorithm models underlying the ALV system, the risk assessment scores for claims, the required TCL values for claims, and the acceptable independent data sources for corroborating claimed loss events, and the relative confidential levels accorded to each such data source. If the configuration is not found, then the audit log 244 is updated by the system to reflect this fact, and the system proceeds to a customer-provided loss verification of the claim.

The ALV process screening step 242 of step 3 is employed by database 246 which stores the requisite data for each client, or else a specific product of that client. Basically, the client can custom tailor a set of rules which determine for each type of its insurance or debt protection contracts or type of beneficiary whether it wants to enable the ALV system 38 for automatically verifying the claim as part of the claim validation process in lieu of the more labor and time intensive customer-provided loss verification process. A particular type of product, claim or beneficiary might present too high a degree of risk for the client to delegate claim verification to the ALV process. If the rules stored in database 246 indicate that the ALV process should not be used, then the audit log 248 is updated to reflect this fact, and the system will proceed to customer-provided loss verification of the claim.

If the rules indicate that the ALV process should be used to evaluate and verify the claim, then the system proceeds to determine whether the configuration type is of a model type (250) for which a RAS value has already been calculated and stored in the system. If the configuration type is of such a model type, then the system, proceeds to the risk assessment determination 252 of step 4. The risk assessment scores (“RAS”) for such beneficial coverage contract is stored in database 254. In process step 4, the system (252) searches database 254 for such RAS for a claim, as well as a hold out sample indicator. If, on the other hand, the configuration type is rule-driven, then the system will execute the rules 256 stored in database 258 to calculate in real time the RAS for that claim. Note that this RAS calculation is tailored to the specific risk acceptance profile of the insurance company or financial institution client, and therefore may vary widely between clients for the same type of claim. If the necessary rules for calculating the RAS for the claim are available, then the system proceeds to node 258. If such rules are unavailable, than no RAS can be calculated for the system to operate the ALV process to verify the claim. Instead, audit log 260 will be updated to reflect this unknown RAS for the claim, and the system will proceed to customer-provided loss verification of the claim.

If a predetermined RAS was found in database 254 for the claim, then the system determines if business rules are present that modify the RAS. Such modification of the client's standard RAS could accommodate special situations like disaster areas where zip code verifications can be unnecessary. This process step utilizes rules and data stored in database 264. Utilizing the learning from the hold out sample analysis described below, the models can “learn” from prior claims experience to adjust the predetermined RAS for the claim where necessary to cause it to accurately characterize as much as possible the genuine risk that the claim poses for fraud or other error. The system then proceeds with the RAS, as modified, to the node 258 of the ALV process.

Having found, modified, or calculated the RAS for the claim at node 258, the system proceeds to step 6 in which a TCL associated with that RAS is retrieved at 266. Such TCLs will be stored in database 268, typically via a “lookup table.” As explained above, this TCL, or total confidence level, score determines the specific tolerance threshold that must be satisfied by the successful match of the corroborating documentary or verbal independent data sources in the aggregate to verify the claim through the ALV process. Higher RAS values will require higher TCL scores to reflect the claim's higher degree of risk to the insurance company or financial institution for fraud or error. Lower risk claims, by contrast, will require a lower TCL score, thereby enabling the claim to be verified via the ALV process with fewer corroborating data source matches. If a TCL is not found by the system for the claim, then the audit log 270 is updated to reflect this fact, and the system will proceed to customer-provided loss verification of the claim.

If a TCL score was found by the system for the claim in Step 6, then the system applies rules stored in database 272 to modify (274) the TCL score, where necessary. Once again, this aspect of the ALV process allows for TCL score to be modified based upon past claims experience to cause it to characterize as accurately as possible the genuine relative risk posed by the claim for fraud or error. Thus, the ALV system 38 of the present invention enables pre-calculation and storage of the RAS and TCL scores for a large number of the insurance company's insurance policies or financial institution's debt protection contracts to speed up the automated claim processing of a claim under such insurance policy or debt protection contract in reliance upon the fact that the system can utilize stored rules to modify the RAS and TCL scores in real time in the interest of accuracy.

In step 8 of the ALV process, the system commences the automated loss verification process 276. This process applies data stored in database 278, including the various corroborating data sources, the specific assignment of particular corroborating data sources to verification of the claim, the pre-assigned confidence level scores for each corroborating data source, look-up data elements needed, and the rules for performing the corroborating data source comparisons against information submitted by the claimant for the claim, as well as information stored on the enrollment and previous claim records. If the claim is a “continuing” claim (e.g., a previously verified disability benefits claim where the claimant has submitted a claim for benefits for the further time period under his policy), then the system will exclude corroborating data sources that were previously utilized to verify the claim and are not multiple hits data sources.

In step 9, the ALV system 38 calculates (280) the RVV for the claim, which as described above represents the AVV for the claim subtracted from its set TCL value. Note that this RVV score will initially be set as equal to the claim's TCL value before the first iteration of corroborating data source retrieval and matching to the claim set-up information.

The system 38 next proceeds to step 10 in which the MVV value for the claim is calculated 282. This process step utilizes information stored in database 284 for the particular corroborating data sources pre-assigned to verification of that claim. As described above, confidence levels for all of these corroborating data sources are combined to produce the MVV or maximum verification value. If the required TCL score for verification of the claim exceeds this MVV value, then this fact is reflected in the updated autolog 286 and the system proceeds with customer-provided loss verification of the claim. Because even a successful match of all the pre-assigned corroborating data sources to the information contained within the claim could not produce enough aggregate confidence value to satisfy the TCL requirement, then there is no point in proceeding with application of the ALV system 38 to the claim in the absence of additional corroborating data sources made available for verification of that claim.

If the MVV value for the combined corroborating data sources available for verification of the claim is determined in step 11 to exceed the required TCL score for verification of that claim, then the system 38 proceeds to step 12 in which the system calculated that the PVV value (288) of all the corroborating data sources for the claim that have not yet been retrieved for verification of the claim and are available for verifying the claimed loss during that iteration. Note that with each retrieval of a corroborating data source, the combined PVV value for the remaining corroborating data sources pre-assigned to that claim will be necessarily decrease.

Database 290 contains the necessary pre-assigned corroborating data sources, confidence levels for those corroborating data sources, and rules for calculating this PVV. Database 290 also keeps track of any corroborating data sources that have already been retrieved and applied against the claim so that they are omitted from the PVV calculation for the current pass.

Also in step 12, the system calculates the running possible verification value (“RPVV”) tally for the ALVS process where:
RPVV=RPVV+PVV.
   This RPVV tally keeps track of all confidence point values for corroborating data sources from previous verification iterations (RPVV) combined with the confidence point values from the corroborating data sources for the current verification iteration (PVV).

In step 13, the system 38 determines whether PVV>0. The only time that the PVV value would not exceed 0 is if all of the pre-assigned corroborating data sources have been retrieved and applied by the system to verify the claim, or if data sources are unavailable. In that case, verification of the claim using the currently available corroborating data sources to satisfy the required TCL value is impossible, so the system aborts further application of the ALV process, and proceeds to node 292.

If, on the other hand, PVV>0, then the system 38 proceeds to step 14 to determine which corroborating data source to retrieve (294) from database 290, based upon a number of factors. First, rules stored within database 290 define a base logic for selecting the specific corroborating data source needs to have been pre-assigned to the subset of corroborating data sources for verifying that claim. Second, each data source has a cost associated with it. Some suppliers of corroborating data sources may charge for each time that the system requests usage of its data source. In some cases, such charges may be significant. In other cases, the insurance company or financial institution may have created a proprietary data source, and it will give priority to using that data source to verify a claim in order to recapture its data source development costs and avoid incremental third-party data source charges.

Third, not all data sources may provide the same success rate for matching claim information to contributor to verification of that claim. Priority should be given to data sources having a higher “hit rate” unless the cost of accessing that particular data source exceeds its value taking into account its hit rate.

Fourth, the RVV value (i.e., AVV−TCL) that needs to be satisfied to verify the claim may be achievable through the retrieval and application of one or a couple of available data sources. It makes more sense to utilize those few data sources to achieve the desired verification outcome instead of a larger number of individually cheaper data sources. Therefore, the rules for data source selection 294 are flexibly reactive to the current status of the ALV process of the present invention.

In step 15 of the ALV process, the particular data source is retrieved and applied 296 against the information supplied within the claim. Data source rules and data rule elements stored within database 298 facilitate the operation of this process. The data sources are derived from both internal data sources 300 and external, third-party supplied data sources 302. If the verification rules for the pertinent data source fail to match the claim information, then it contributes no confidence level points to the AVV score for the claim. If, on the other hand, the data source does successfully match the claim information, then it has corroborated the claim, and its pre-assigned confidence level points are added to the running AVV tally 304 for the claim in step 16.

In step 17, the RVV score for the claim is recalculated 306 by subtracting the updated AVV tally from the required TCL value for verifying the claim. At this point, the updated AVV and RVV scores, along with identification of the corroborating data source successfully matched against the claim, are added to the audit log 308, with the information stored in database 310.

Next, the ALV process proceeds to step 19 in which the updated AVV score is compared (312) against the required TCL score for the claim. If AVV≧TCL, then the required TCL threshold has been satisfied by the ALV process, and this information is recorded in audit log 314. The verified claim will then be sent by the ALV system to the adjudication phase 100 (see FIG. 3).

If, however, AVV<TCL for the claim, then the claim has not yet been verified. In step 20, the system determines (316) whether additional corroborating data sources are available for retrieval and application to the claim in accordance with the rules and base logic 294 of step 14. If no more corroborating data sources are available, then the ALV process and implementing system proceeds to node 292.

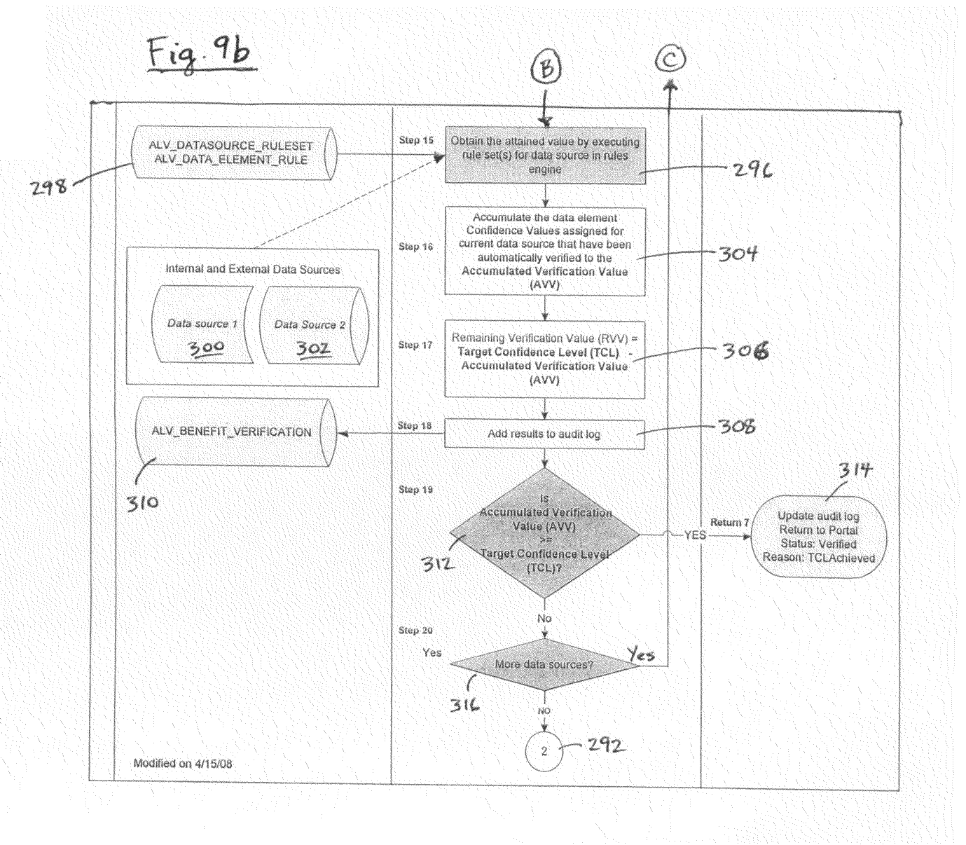

Turning to FIG. 10, a claim for which no more corroborative data sources 300, 302 are available proceeds to step 21. In this ALV process step, the system determines 320 if RVV>MVV−RPVV. If yes, then the system updates autolog 322 to reflect the fact that the required TCL score cannot be achieved. The system then returns to the portal with the claim unverified.

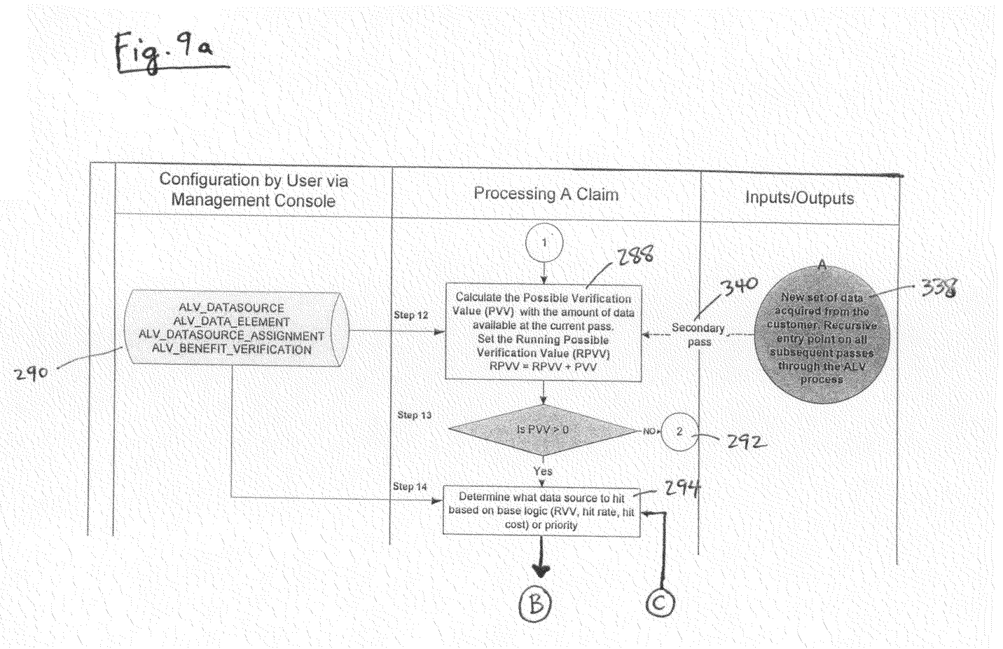

If, however, RVV=MVV−RPVV, then the system proceeds to step 22 to determine 324 what corroborative data sources to hit based upon the base logic stored in database 325 or priority. These additional corroborative data elements must be requested 328 from the claimant pursuant to step 23. The phrase for the request is supplied by database 330, and the autolog 332 is updated. The system returns to the portal to request 334 this additional information from the customer, because the required TCL score is achievable if one or more corroborative data sources are made available pursuant to the claimant's answers to the posed questions. Any such new bit of data acquired from the customer 338 is utilized by the system in a secondary pass 340 (see FIG. 9) to initiate once again the recursive query process for verifying the claim starting at PVV calculation step 288 (step 12).

### Example 4

An example of the ALVS process depicted in FIGS. 8-10 is provided as follows:
Required TCL for claim verification: 70%
MVV=90%
Corroborative data sources:
   SSN database=20%
   Date of Death database=30%
   Obituary publication database=30%
   Verbal confirmation=10%.
1^{st} Iteration:
   Only SSN and Date of Death data sources are available.
   RVV=TCL=90% (Step 9).
   MVV=90% (Step 10).
   Because TCL≦MVV, then proceed (Step 11).
   PVV=20%+30%=50% (Step 12).
   RPVV=RPVV+PVV (Step 12).
      RPVV=0%+50%
      RPVV=50%
   PVV>0, so proceed (Step 13).
   System obtains positive hits for both SNN and Date of Death data sources (Steps 14-15).
   AVV=20%+30%=50% (Step 16).
   RVV=TCL−AVV (Step 17)
      RVV=70%-50%=20%.
   AVV≦TCL, so proceed with 2^{nd} Iteration (Step 19).
   There is a new obituary data source available (Step 20).
   Is RVV>MVV−RPVV? (Step 21)
      20%≦90%-50%
      20%≦40%, so proceed.
2^{nd} Iteration:
   Obituary database worth 30 confidence points
   PVV=30% (Step 12).
   RPVV=RPVV+PVV (Step 12)
      RPVV=50%+30%
      RPVV=80%
   PVV=30%>0, so proceed (Step 13).
   System does not obtain a successful match (Steps 14-15).
   AVV=50% still (Step 16).
   RVV=TCL−AVV (Step 17)
      RVV=70%-50%
      RVV=20%.
   AVV≦TCL, so proceed to 3^{rd} Iteration (Step 19).
3^{rd} Iteration:
   There is a new verbal data source available (Step 20).
   Is RVV>MVV−RPVV? (Step 21).
      20%>90%-80%
      20%<10%, so end ALVS process, because the 10-point verbal data source is insufficient to satisfy remaining TCL gap.
Therefore, the claim cannot be verified by ALVS process.

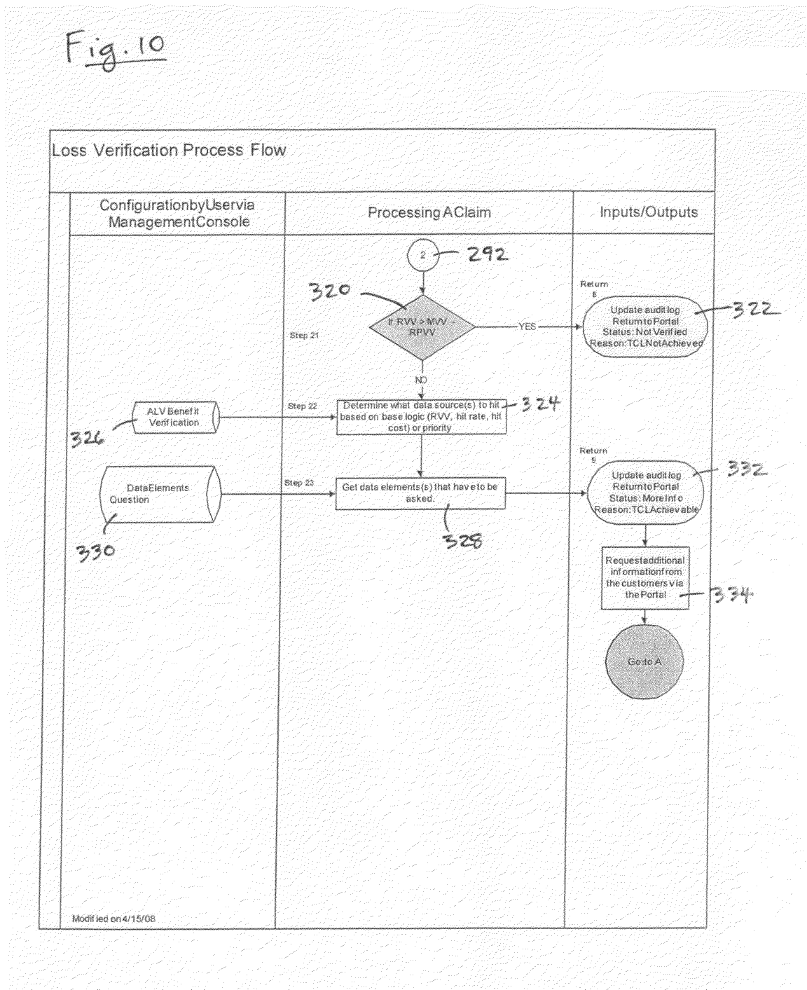

An important component of the ALV process and system 38 of the present invention is the process for defining the RAS for the various claims. As shown in FIG. 11, risk assessment process (“RAP”) 36 is run automatically on a periodic date and time basis 352. Such RAS will be computed via coded computer server runs 354, utilizing input data from several databases. The CDS database 356 stores enrollment data for the pending insurance policies and debt protection contracts, as well as a record of pending claims brought under those policies and contracts, and the premiums paid under such policies and contracts to offset the risk of the insurance company or financial institution having to pay off a claim thereunder. The CMS database 358 contains data for all enrollment staging, pending claims actions staging, and premium staging. Finally, database 360 stores policy and contract holder identification data on a group basis, such as in terms of zip code, household, or a block group.

Note that the operator of the ALV process may also choose to perform a manual run 362 of the risk assessment tool 364. The decision science market analyst 366 for the operator will do this if he has a concern that the RAS for pending claims needs to be updated for the sake of accuracy.

Running the risk assessment tool 36 on the computer server will yield a series of RAS 370 for the various policies and contracts. This TS scoring application is checked for errors. If there are errors, then the science team is notified 372. Corrections to the RAP models are made 374, and the models are rerun pursuant to step 350.

If no errors in the RAT models are detected, then the decision science team will send the updated RAS file to the server 376. Data Warehouse 378 will pick up the updated RAS file and update the risk score table. The data warehouse will export the current RAS 380 to the claims processing system 10 to update the RAS table. An e-mail is then sent by the system to the appropriate science teammates to notify them that the periodic (e.g., weekly) RAT 36 file was successfully run.

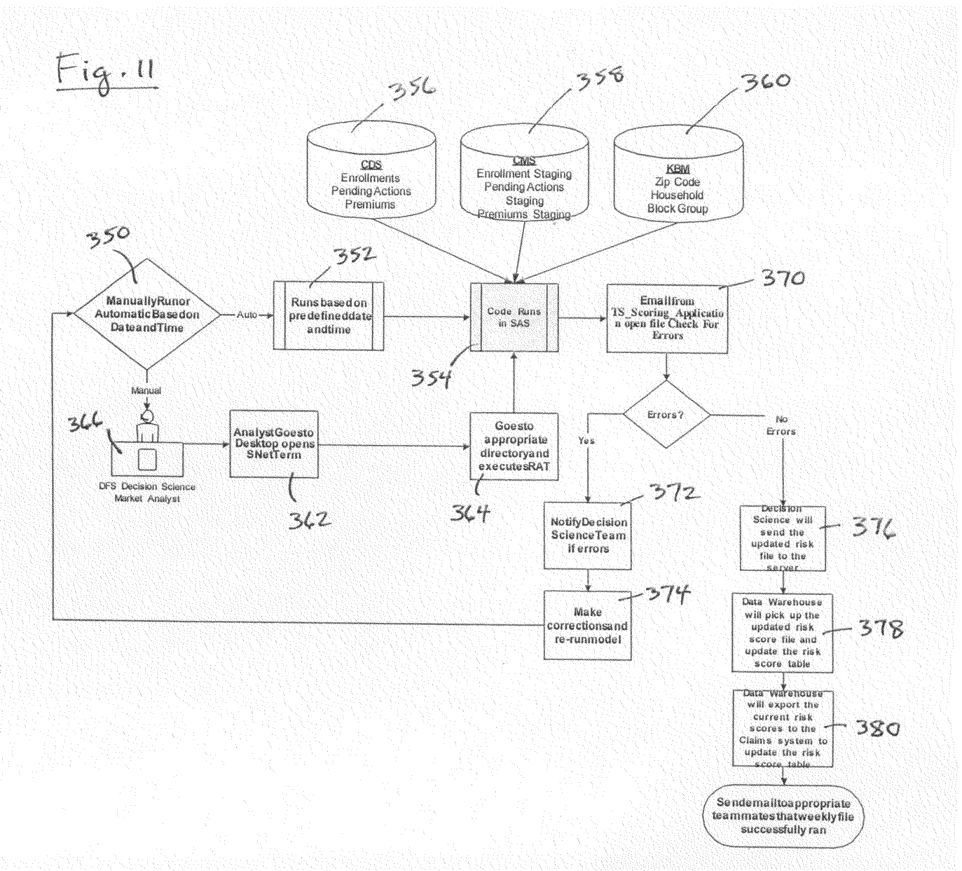

FIG. 12 shows in greater detail the use by the ALV system 38 of the risk assessment tool 36. The claimant supplies the necessary information characterizing the claim being made under the beneficial coverage contract 400. The customer reviews the confirmation page summarizing this descriptive claims information 402 and submits the claim 404.

The ALV system 38 then requests retrieval of the claimant and associated RAS for the type of loss being claimed 406. If the claimant name and RAS are not found (408), then the audit log 410 is updated to reflect this fact. If, however, the claimant name and RAS are found by the system (412), then the associated rules engine is checked 414 to determine whether the client (insurance company or financial institution) has established any specific rules 416 for modifying the RAP score 418. The audit log 420 is updated to identify the date, time, claimant, policy or contract number. The original RAS and modified RAS are also recorded.

The system then checks the rules established by the insurance company or financial institution to determine whether the ALV process should be bypassed 422 during adjudication of the claim. If the rules state that the ALV process should be bypassed (e.g., if the nature of the loss requires specific documentary proof such as death certificates for accidental death claims, or documentation of Social Security Disability for permanent disability claims), then the claim proceeds straight to adjudication 424 under the terms of the insurance policy or debt protection contract.

If, on the other hand, the rules state that the claim should be subject to the ALV process, then it proceeds to ALV verification 426 based upon the RAS for the claim. In an important aspect of the invention, a certain number of claims on a random basis are designated as “hold out samples” 428. This means that in addition to being verified by the ALV process 38 and adjudicated in accordance with the invention, the claim outcome is followed up at a future point in time to determine whether, in fact, it was legitimate under the terms of the policy or contract, or whether it was fraudulent or erroneous. By comparing the actual result of the hold out sample claim against its predicted outcome by the RAT and ALV verification process, the system operator can identify any discrepancies. In this manner, the RAT and ALV process parameters can be modified where necessary to improve the predictor accuracy of the RAT and ALV process.

Another crucial aspect of the present invention is the management console for the ALV system 38. Comprising a software program and associated graphical user interfaces (“GUIs”), this management console permits the insurance company, financial institution, or other system operator to set up and maintain the different parameters for operating the ALV process 38.

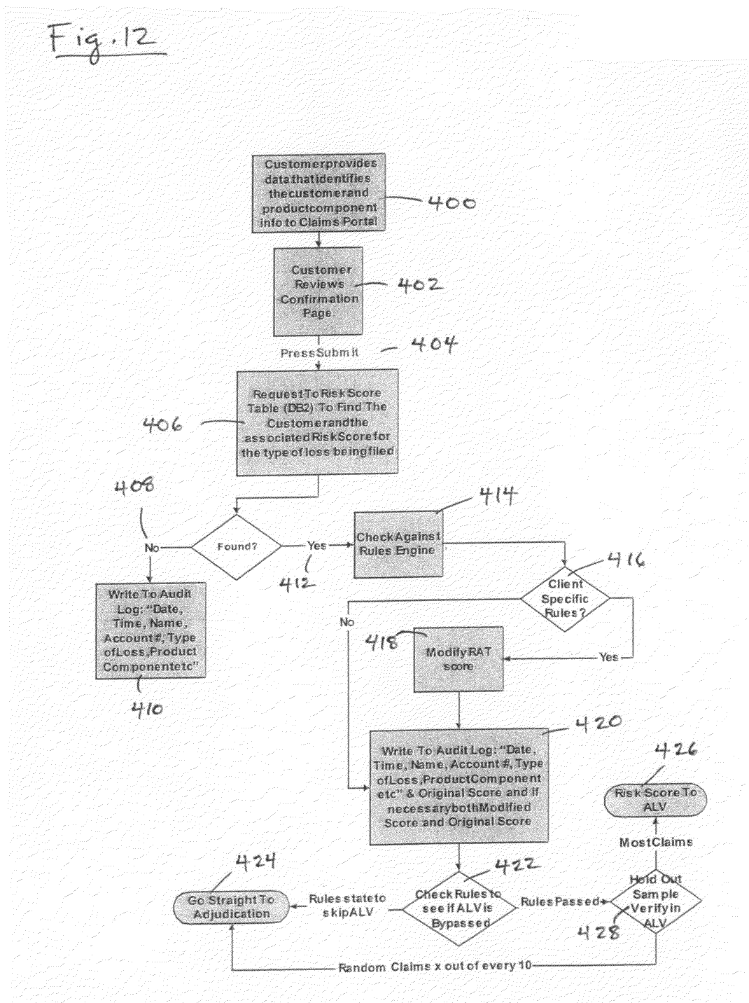

FIG. 13 shows the login screen 450 for the ALV system 38. It contains a User ID field 452 in which the user enters her assigned identification name for the server upon which the ALV Management Console resides. The user also must enter a predetermined password in field 354 for security purposes. After clicking the “log in” icon 456, the system will check its roster of User IDs and associated passwords to provide user access to the ALV Management Console only if there is a precise match. If the user forgets her password, she can click on the “forgot your password” hyperlink 458 in which case the system administrator will email her a substitute password, as it is known in the computer arts.

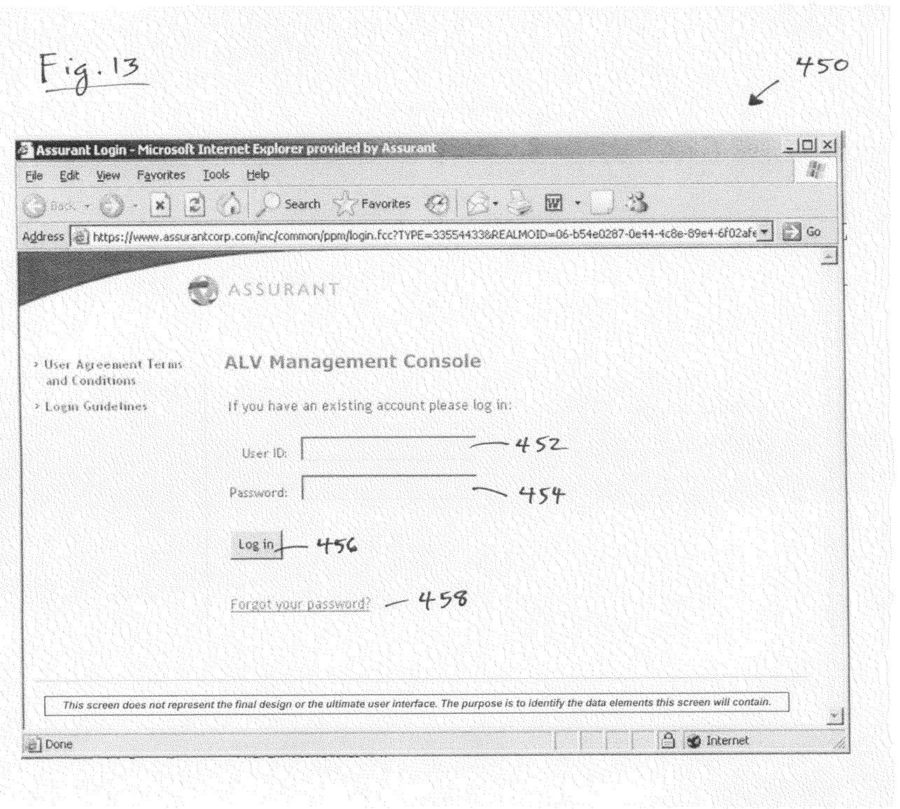

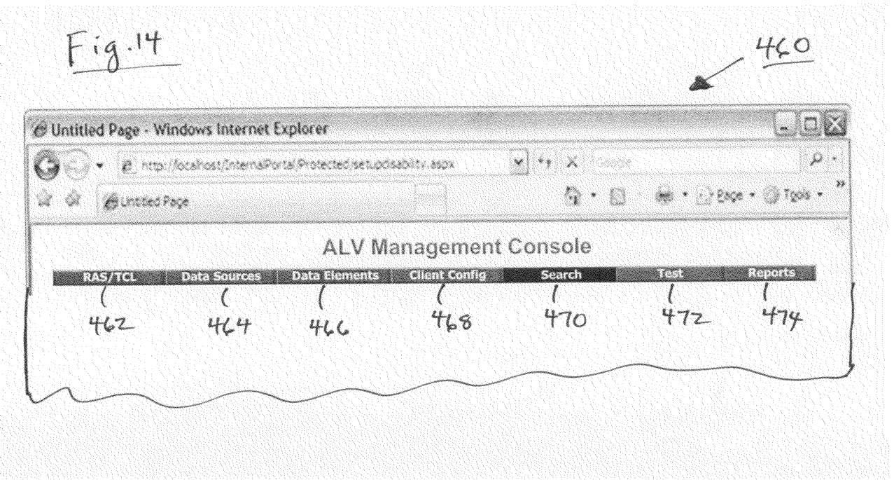

The home page 460 for the ALV Management Console of the present invention is shown in FIG. 14. Located on the home page GUI are a series of icons: RAS/TCL 462, Data Sources 464, Data Elements 466, Client Configuration 468, Search 470, Test 472, and Reports 474. The functionalities of these icons will be described below.

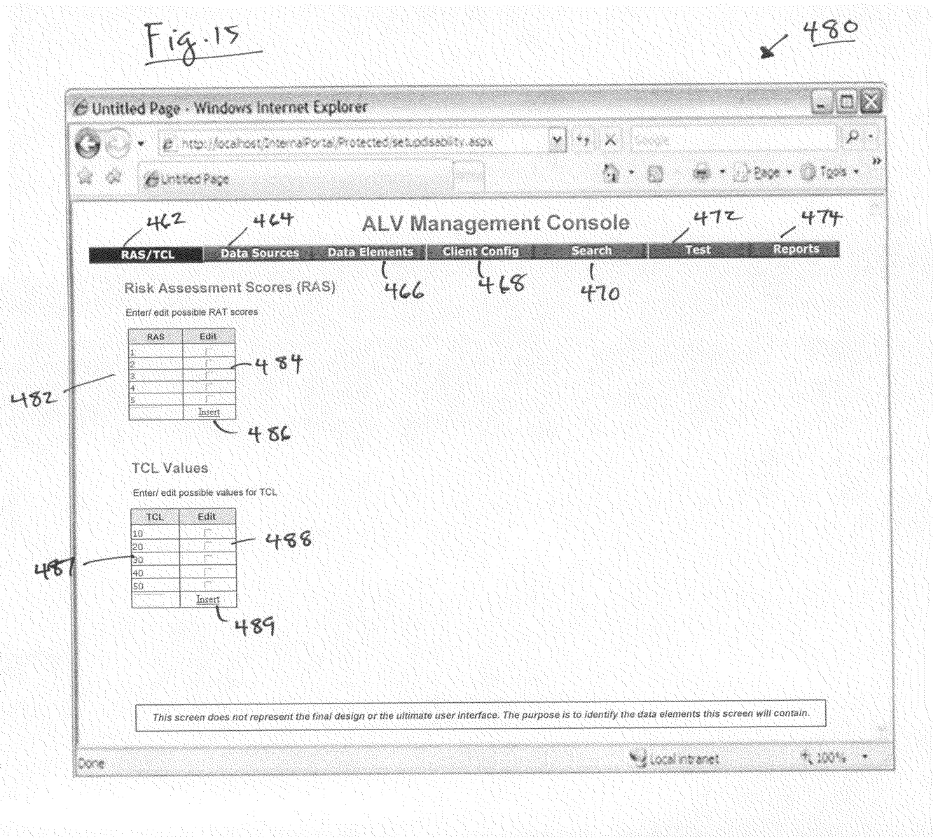

By clicking on the RAS/TCL icon 462, GUI 480 is called forth, as depicted in FIG. 15, which enables the systems operator to insert or delete values for risk assessment scores (“RAS”) and total confidence level (“TCL”) values for a particular insurance company or financial institution. RAS values are numbers with no decimal points. The numbers can lie between −999 and 999. TCL values are numbers with no decimal points greater than or equal to zero and less than 999. Thus RAS and TCL values are stored in one or more system databases.

The current RAS values are represented in fields 482. By clicking on a radio button 484, the corresponding RAS value can be edited by clicking on to the “Insert” hyperlink 486.

The current TCL values are depicted in fields 487. By clicking on a radio button 488, the corresponding TCL value can be edited by clicking on to the “Insert” hyperlink 489.

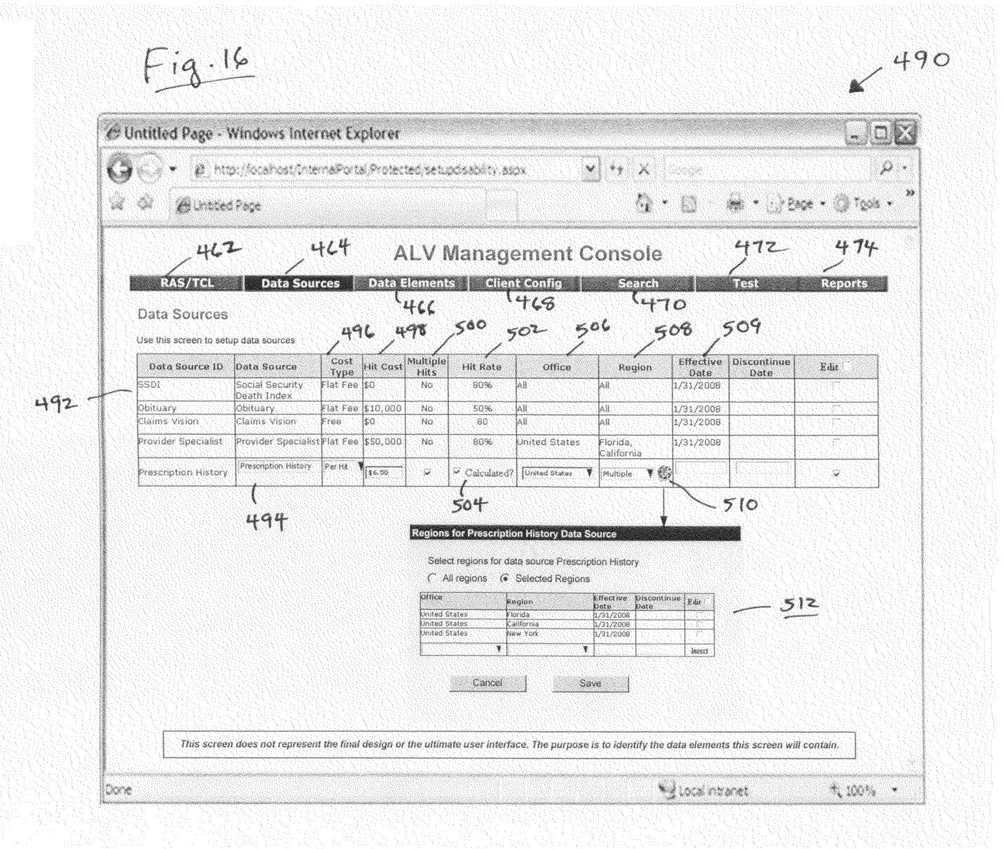

The data sources GUI 490 shown in FIG. 16 is accessed by clicking on “data sources” icon 464. This screen allows the systems operator to set up the corroborating data sources for the ALV system 38 uses for claims verification. Settings in this session apply to the corroborating data sources.

Field 492 allows the data source to be identified with the formal name entered into field 494. The cost basis for the data source (e.g., free, flat fees, per hit) is entered into field 496. The actual cost for the data source usage is entered into field 498. The multiple hits field 500 shows by a “yes” or “no” entry whether the particular data source can be invoked multiple times for purposes of verifying the loss event. For example, the prescription history database shown in FIG. 16 as being checked “yes” is a date-driven database, so it can provide updated verification information several times throughout the claims verification process. By contrast, the doctor specialist database provides a single data point for all time with respect to the claim. Therefore, the system should only consult this doctor specialist database once during the claims verification process

The “hit rate” for each corroborating data source is calculated on the total number of valid hits divided by the total number of hits. This value can be expressed as a percentage and characterizes the usefulness of the data source for verifying a claim, and is entered into field 502. The hit rate value can be entered manually by the system operator. Alternatively, it can be calculated automatically by the system if the “calculated” radio button 504 is checked. The “office” field 506 and “region” field 508 indicate the geographic applicability of a particular corroborating data source for verifying claim information. “Office” refers to the client's country of operation. “Region” refers to a state or province within that country. The effective date of the data source data entry or revision is identified by the system within field 509.

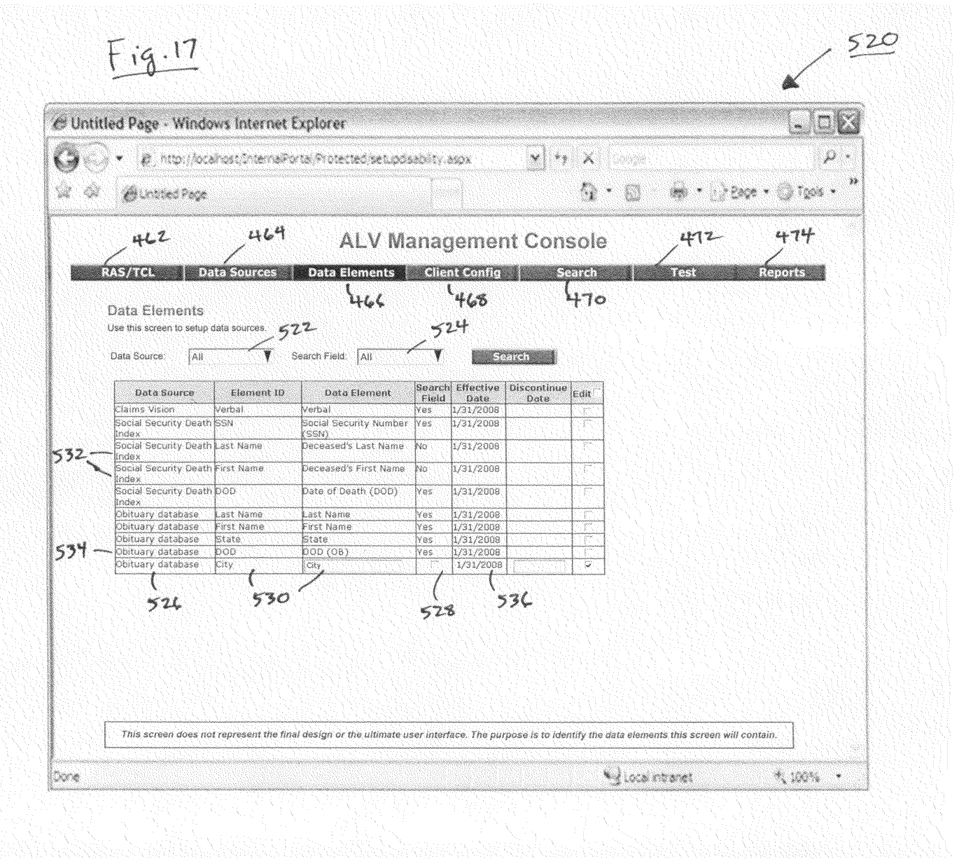

Clicking on the world globe symbol 510 opens a pop-up window 512 which permits selection of the region (all vs. selected regions). By clicking on “data elements” icon 466, the computer ALVS system 38 calls forth the GUI 520 shown in FIG. 17. This screen allows the data elements for every corroborating data source to be entered by the systems operator. Settings in this screen apply to all client configurations.

The corroborating data elements can be filtered by the “field source” drop down box 522 or else the “search field” drop down box 524. This screen allows the data element name to be modified in field 526, and to establish whether or not the data element is field searchable in field 528. The data element name cannot have more than 50 characters. The “search field” determiner of the data element is being used or not via a rule set for data verification, and if the claimant has to provide the information for the element. The application uses this field to determine additional questions.

Authorizations and consents are considered to be data elements. Thus, if a data source requires authorization before it is hit, then this authorization will be set as a data element.

Field 530 defines the particular element that is searchable for each data source. For the Social Security Death Index 532, this might be the deceased's first or last name. For the obituary data base, it might be the deceased's date of death 534. The effective date of the data source entry is identified by the system within field 536.

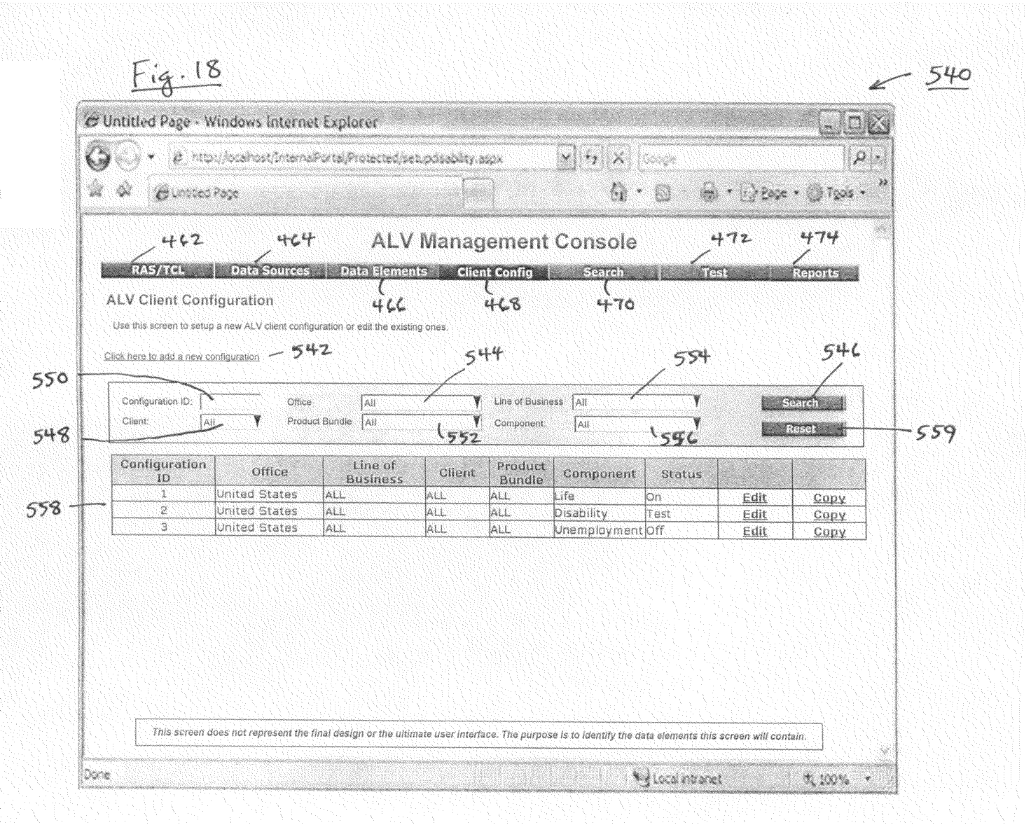

FIG. 18 illustrates ALV client configuration GUI 540, which can be accessed by clicking on icon 468. This ALV client configuration gathers all configurations that fall under the same office (e.g., United States, Canada, Puerto Rico), line of business (e.g., insurance, debt protection), product bundle, client, and component. The ALV system 38 uses this configuration to determine which corroborating data sources and rules to employ to verify a benefit claim.

The GUI screen 540 displays the existing ALV system client configurations. It also allows new client configurations to be created by clicking on the “click here to add a new configuration” hyperlink 542. Existing client configurations can also be edited.

Client configuration entries can be easily searched. For example, to obtain a list of all the ALV configurations for the United States office of the insurance company or financial institution, “United States” should be inserted within the “Office” field 544 and the “search” button 546 clicked. To obtain all of the configurations for Client A, “Client A” should be inserted into “Client” field 548, followed by activation of the search button 546. Other searchable fields for client configurations include “Configuration ID” field 550, “Product Bundle” field 552, “Line of Business” field 544, and “Component” field 556. All of the relevant field information for a particular client configuration is depicted in summary box 558. The “reset” button 559 allows a new search to be conducted.

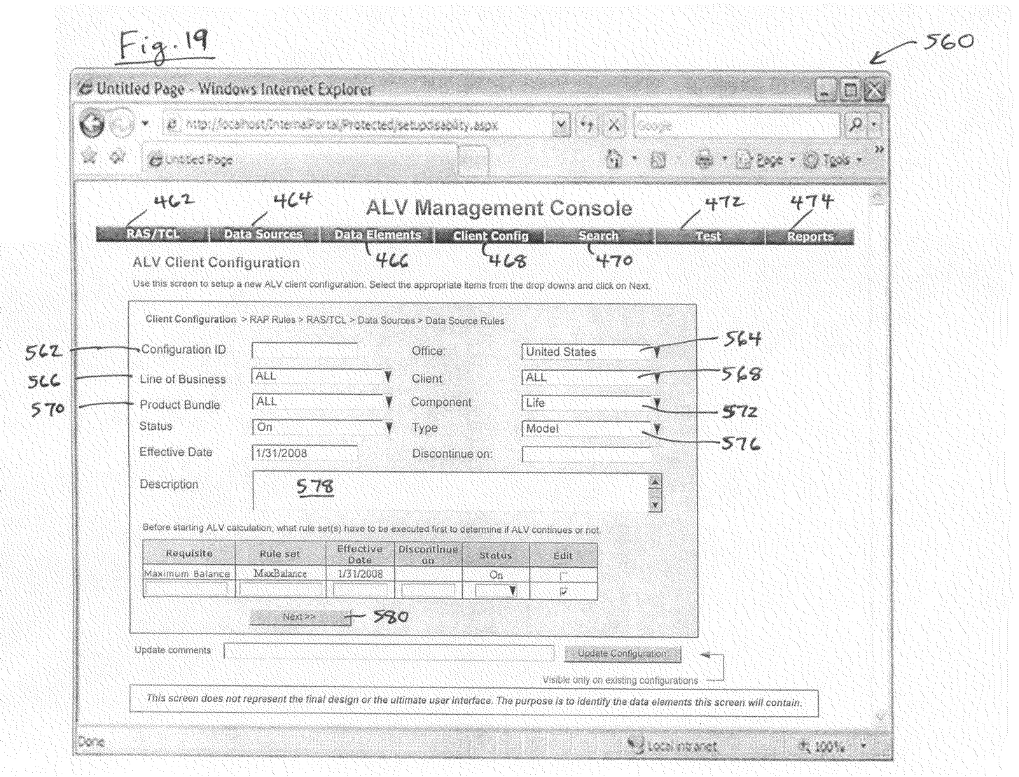

FIG. 19 shows GUI 560 for creating a new client configuration. It is accessed by clicking on hyperlink 542 in GUI 540. The ALV system 38 will assign a “Configuration ID” in field 562, which can constitute numbers, letters, or a combination thereof. Drop-down boxes provide a convenient means for the systems operator to enter pertinent identifying information for office (564), client (568), product bundle (570), and component (572). The status of the configuration (i.e., on, off, test) may also be inserted into drop down box 574. The type of beneficial coverage contract (e.g., insurance, debt protection) is entered into drop down box 576. Finally, comments concerning the client configuration can easily be entered by the systems operator into field 578.

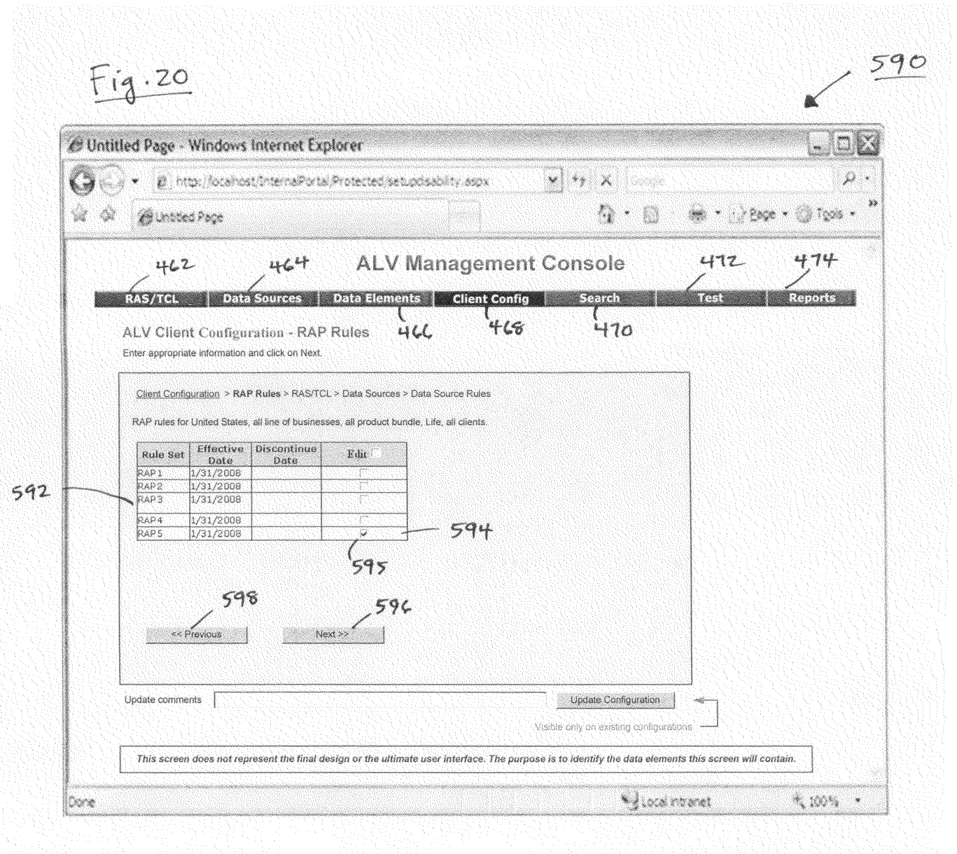

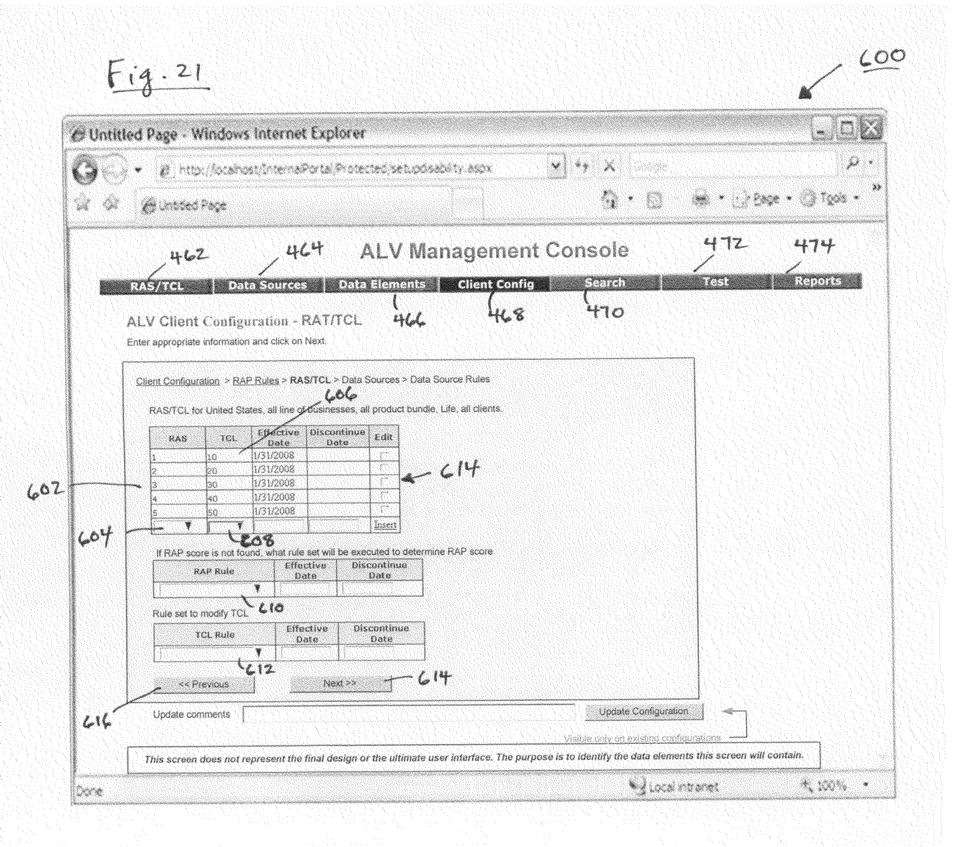

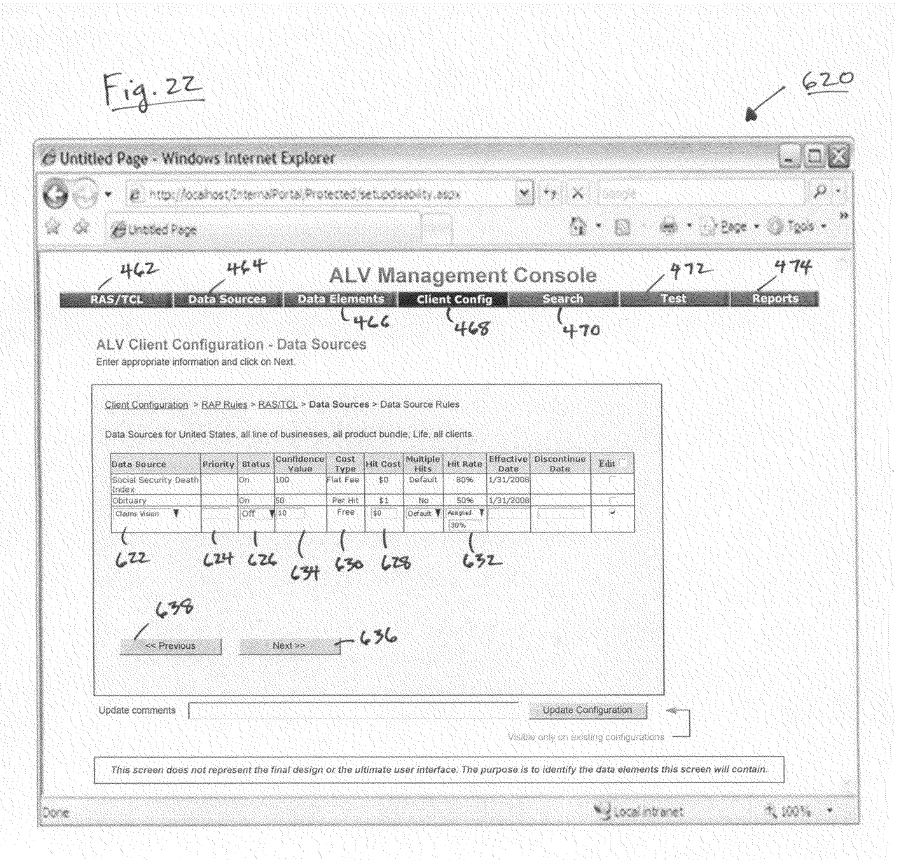

Clicking “next” button 580 brings the systems operator to GUI 590 depicted in FIG. 20 for selecting the rule set from the rules engine 108 that should be applied to the client configuration. These are the risk assessment process (“RAP”) rules that are applied by the ALV system to modify the pre-assigned risk assessment score (“RAS”) for the insurance policy or debt protection product of the particular client configuration entry. This screen allows the RAP rule bits to be inserted, updated, and deleted. The RAP rule bits are inserted into fields, while clicking on a radio button 595 in entry column 594 allows an existing RAP rule entry to be edited. “Next” button 596 enables the systems operator to proceed to GUI 600 shown in FIG. 21. “Previous” button 598 allows GUI 560 to be revisited. GUI 600 provides the translator table used by the ALV system 38 to convert RAS to an ALV target confidence level (“TCL”). The available RAS values are entered into RAS fields 602 with the assistance of drop down box 604. Next, the TCL values chosen by the insurance company or financial institution for a particular RAS score are entered into field 606 with the assistance of drop down box 608. The rule set selected for calculating the RAS score for the insurance policy or debt protection contract in case a RAS score has not been pre-assigned is entered into field 610 with the help of a drop down box. Finally, the rule set for modifying the TCL value resulting from translation table 614 is entered into drop down box 612. “Next” button causes the system to proceed to GUI 620 shown in FIG. 22.

GUI 620 enables the entry of corroborating data sources and their respective confidence values. These data sources are used by the ALV system 38 to verify a claim, as described above. The data sources can be inserted, deleted, or updated via this screen. The identify of the data source is entered into field 622 with the assistance of a drop down box. The drop down box shows only relevant available corroborating data sources for that particular type of insurance policy or debt protection contract. For example, only life-related data sources (e.g., Social Security Death Index, Obituary database) will be shown for a life insurance policy. The system also takes into account the office set for the data source.

The “priority” field 624 is a number from 0-99, and is not required for creation of a data source entry. “Status” field 626 is a drop down box which provides the choices: on, off, and test.

The “confidence value” field 628 is the repository for the relative confidence level assigned by an insurance company or financial institution to each data source. It will typically be a percentage between 0 and 100. Each corroborating data source will have an access cost associated with it. This cost number is entered into field 628 along with the type of cost (e.g., flat fee, per hit, free) inserted into field 630. “Hit Rate” 632 is a drop down box with three options: default, calculated and assigned. “Default” means that the hit rate that was entered into the data sources screen should be used. “Calculated” means that the system should automatically calculate the value in accordance with the formula:

$$Hit Rate = \frac{Total number of valid hits for this configuration}{Total number of hits for this configuration}$$

“Assigned” means that the system operator should enter the value manually.

The “Multiple Hits” field 634 allows entry of the choices: Yes, no, and default. This determines whether a data source can be hit multiple times by the system for the same claim. If “default” is chosen, then the information taken from the data sources screen is used.

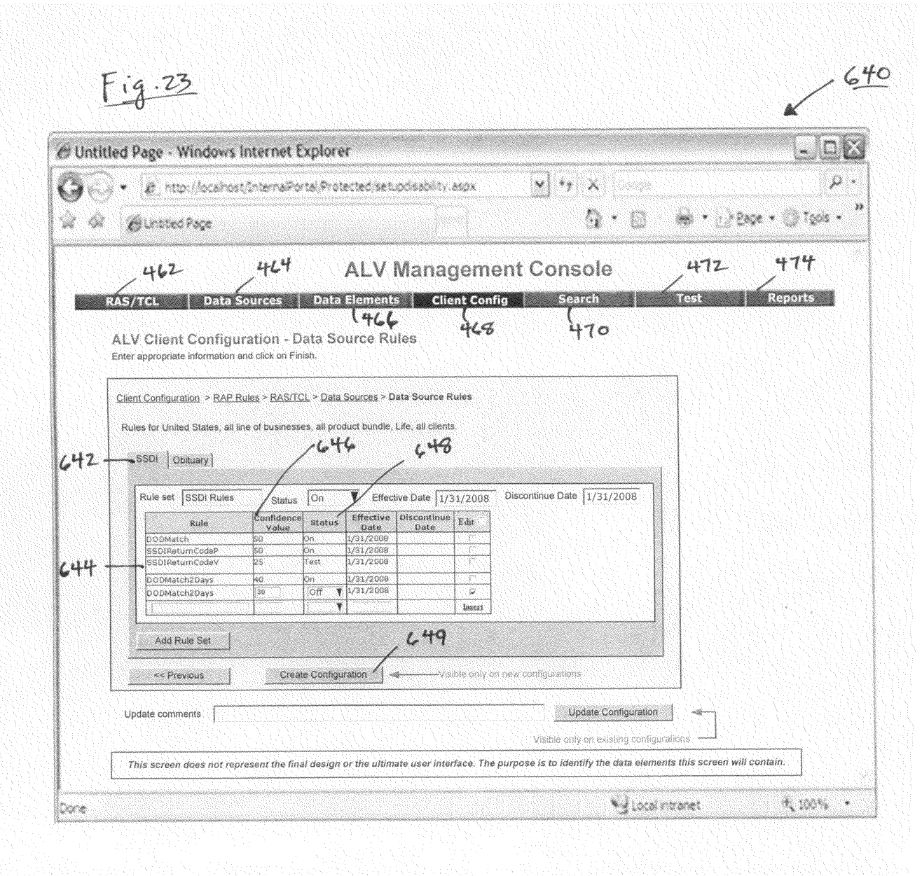

By clicking on “Next” button 636, GUI 640 shown in FIG. 23 is accessed to specify the rule sets applied to the various data sources to verify the claim information, as described above. It also allows the setting of the confidence value and status for every rule in the rule set.

There is a tab 642 for every data source for the current configuration. Every data source must have at least one rule set 644. The rule set is the rule set ID that was assigned in the rules engine. The confidence value for the data source is entered into field 646, while the status of the associated rule (on, off, test) is represented in field 648.

The sum of all the rules' confidence values for a data source cannot exceed the confidence value assigned for the data source. The application saves the configuration when the system operator clicks the “finished” button 649. Before saving the information, the software application validates that there are no two configurations having the same settings.

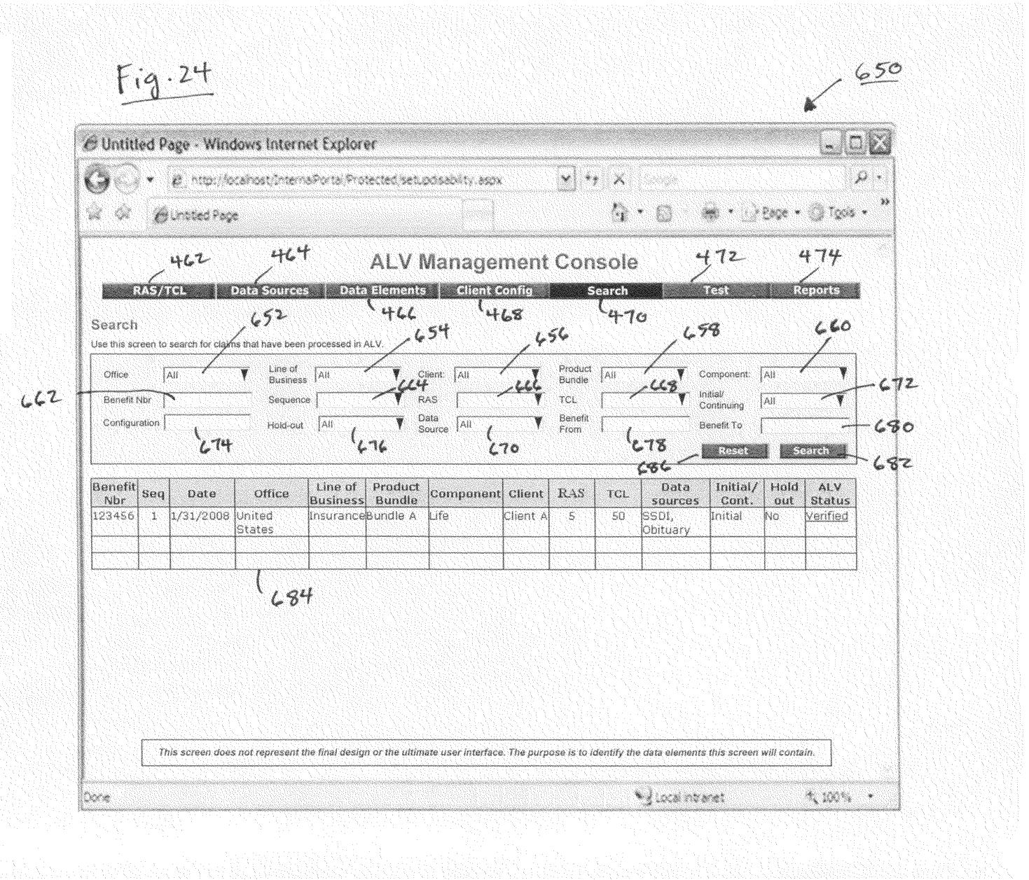

FIG. 24 shows GUI 650 for searching claims that have been processed by the ALV system 38. This screen does not serve as a report for processed claims. It is accessed by clicking on “search” icon 470.

GUI 650 allows searching claims by any combination of the following elements:
Office (652): Drop down with list of offices. Option “All” is available.
Line of Business (654): Drop down with values depending on the selected Office. Option “All” is available.
Client (656): Drop down with list of clients. The list depends on the selected Office and Line of Business. Option “All” is available.
Product Bundle (658): List of product bundles depending on selected Office, Line of Business and Client. Option “All” is available.
Component (660): List of components depending on the selected Office, Line of Business, Client and Product Bundle. Option “All” is available. Benefit Number (662): Text box to enter Benefit Number.
Sequence (664): Drop down with sequence numbers depending on Benefit Number.
RAS (666): Drop down with possible risk scores. Option “All” is available.
TCL (668): Drop down with possible TCL values. Option “All” is available.
Data Source (670): Drop down with list of data sources. This list is filter based on the selected Component.
Initial Continuing (672): Drop down with three options—“All,” “Initial,” and “Continuing.”
Configuration (674): Text box to enter ALV Client Configuration ID.
Hold out samples (676): Drop down with three options—“All,” “Yes” or “No.”
Benefit From (678): Text box to enter date.
Benefit To (680): Text box to enter date.

The search returns all the records that match the selected criteria. It shows the following fields:
Benefit Number
Sequence Number
Date when ALV verified benefit
Office
Line of Business
Product Bundle
Component
Client
RAS
TCL
Data Sources
Hold out
Status

Clicking on the “search” icon 682 pulls up the processed claim entries, which are summarized in box 684. “Reset” button 686 allows another search to be conducted.

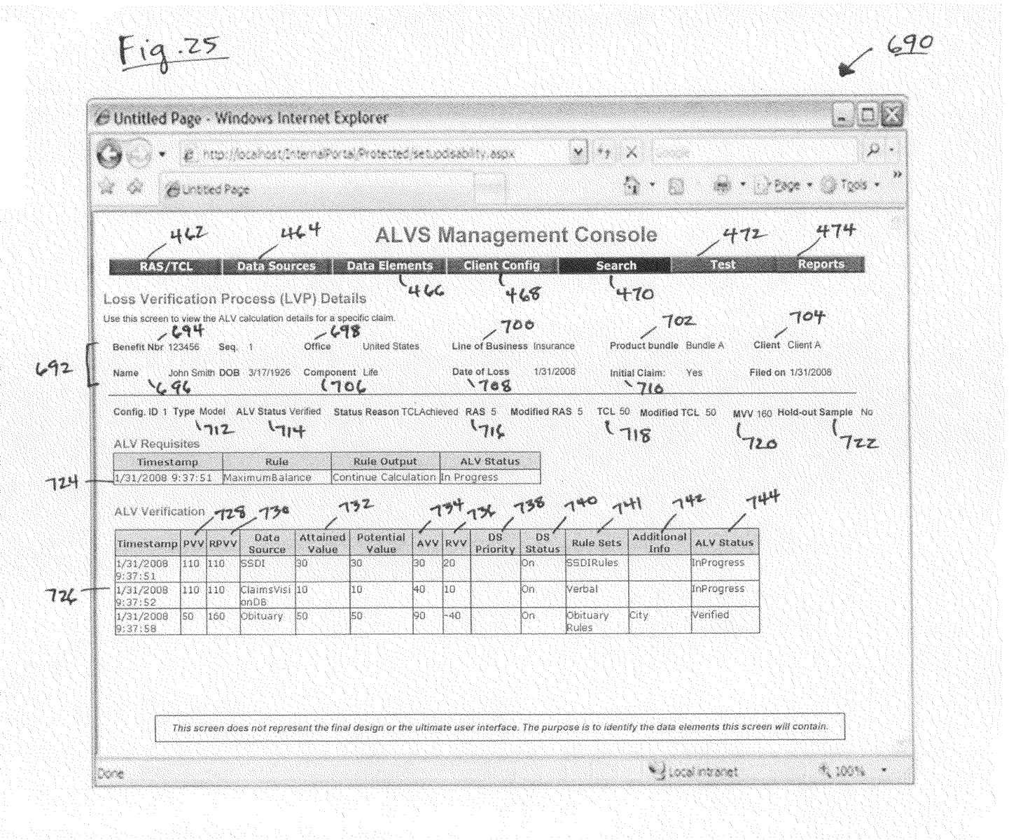

GUI 690 illustrated in FIG. 25 shows all the details of a selected processed ALV system verification. In the upper field 692, it shows the benefit number 694, claimant name 696, office 698, line of business 700, product bundle 702, client 704, component 706, date of loss 708, initial or continuing benefit status 710, ALV client configuration ID 712, ALV status 714, RAS score 716, TCL score 718, MVV value 720, and hold out sample 722. this information is pulled by the system for the databases. The screen also depicts in table 724 the rule sets, if any, that were executed by the ALV system 38 to determine if the ALV verification process should proceed.

Finally, GUI 690 shows in table 726 all the data sources that were utilized to validate the claim and the resulting PVV 728, RPVV 730, attained value 732, AVV 734, RVV 736, data source priority 738, data source status 740, and rule sets 741 used to verify the information. If additional information was requested from the claimant, this fact is reflected in field 742. The ALV status is stated in field 744 for every iterative usage of the data sources.

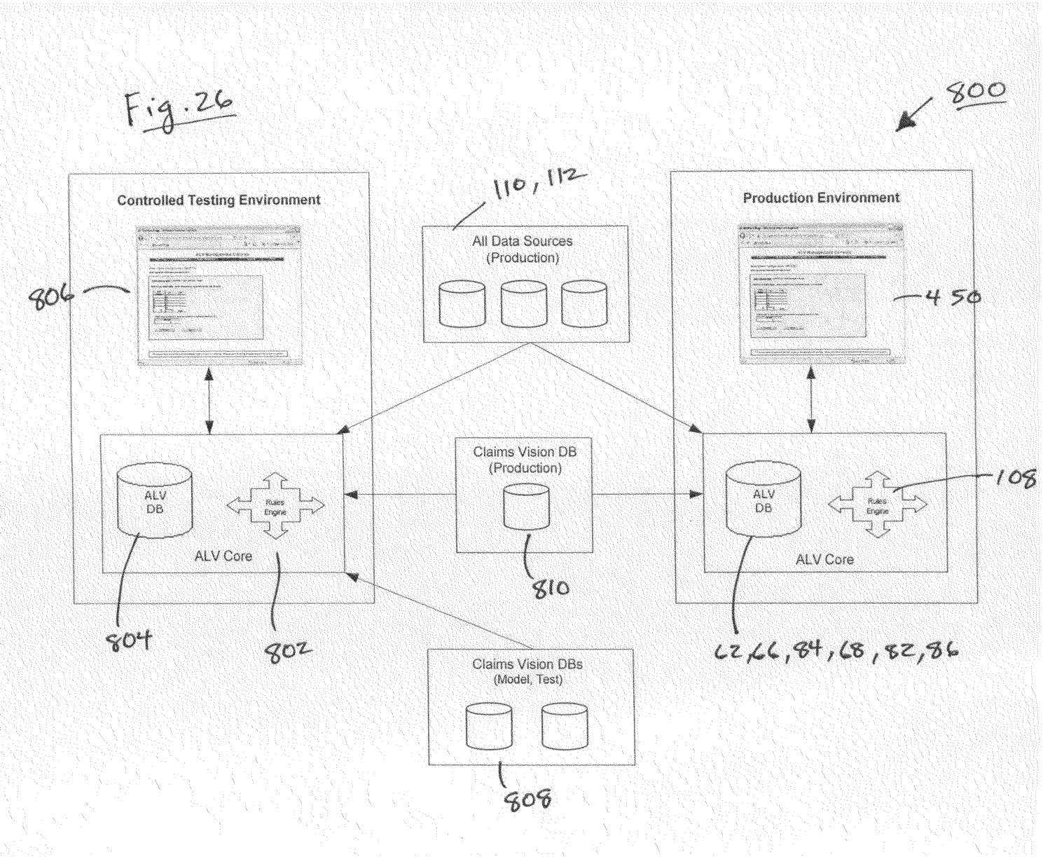

Yet another important feature of the automated loss verification tool 38 of the present invention is its “control testing environment” module 800. As depicted in FIG. 26, it comprises a parallel rules engine 802, database 804, and set of management control GUIs 806 that are accessed by “test” icon 472 of the ALV management console (see FIG. 14). This control testing environment module is used to test any proposed changes to the ALV configurations or rules before they are incorporated into the production system. The rules engine 108, associated databases 62, 66, 68, 82, 84, 86, and management control GUIs 450 for the production system have already been described above. Corroborating data sources 110, 112 support both the production system and the control testing environment system. By having its own rules engine 802 and associated databases 804, test data can be sourced either from historic claims contained in claims vision production database 810, or entered manually via claims vision test database 808.

In this manner, the systems operator can modify important input variables to the ALV system, such as RAS values for a claim, the required TCL values for the claim, the confidence points values assigned to the corroborative data sources (both internal and external), new internal or external corroborative data sources, the combination of corroborative data sources assigned to verify a specific claimed loss, the order of query for such corroborative data sources combination assigned to that claim, etc. to determine within a controlled test environment the performance results for the ALV system 38. The systems operator will want to make sure that the proposed changes to the ALV system parameters produce a benefits result that accurately verifies the tested claimed loss before the modifications are actually incorporated into the rules engine and databases for the production system. Thus, this control testing environment module 800 enables the ALV system 38 to be verified, maintained, and adjusted, as needed, to ensure optimization of the system 38.

### FURTHER EXAMPLES

The following three examples illustrate a claim in which the insurance company validates a claim by seeking verification from a source independent of the claimant.

### Example 5

A customer files a death claim and the claim is scored as low-risk. The alternative minimum acceptable methods of validation for approval include: (a) review the published obituary; (b) obtaining confirmation from a government agency that the individual is deceased; or (c) obtaining a death certificate. In this example, the system would automatically search a purchased obituary database published in a reputable news on-line service for an individual matching the facts provided by the beneficiary. The web is not a valid source for an obituary unless it is on an official news site. If there is a match, the claim is automatically approved. If no match is found, the system automatically searches the social security database for an individual reported deceased matching the facts provided by the beneficiary. If a match is found, the claim is automatically approved. If no match is found, the system notifies the customers that they must provide proof of death by sending a death certificate.

### Example 6

A customer files a death claim and the claim is scored as medium-risk. The alternative minimum methods of validation for approval include: (a) obtaining confirmation from a government agency; or (b) obtaining a death certificate. In this example, the system would automatically search the social security database for an individual reported deceased matching the facts provided by the beneficiary. If a match is found, the claim is approved. If no match is found, then the customer would be notified to provide a copy of a death certificate.

### Example 7

A customer files a death claim and the claim is scored as high-risk. The only acceptable method of validation for approval is a death certificate. The customer is asked to provide a death certificate.

Examples 1 and 2 illustrate situations in which the process is to automatically search various sources to confirm the event (death) independent of the claimant's assistance. In these examples, if the system is successful in validating the death via one of the independent validation alternatives, the customer is informed immediately that the loss has been verified without need for further customer-provided verification. The benefit is that the customer is freed of the burden, the claim is approved faster, and the insurance company or lender completes the transaction more efficiently.

The following examples illustrate a situation in which an insurance company or lender validates a claim by independently compiling information from various sources to increase the confidence they have in the assertions made by the claimant.

### Example 8

A claimant files a disability claim. They have become unable to work as a result of a recent heart attack. The customer calls the insurance company to file a disability claim. The company collects the information associated with the event including the date of the heart attack, the attending physician, medications prescribed, length of stay in the hospital. The system validates automatically that the physician identified by the customer is a cardiac specialist. It also validates that the medication identified is typically prescribed for heart attack victims. The system also automatically validates against a prescription data base service that the customer received the prescription drugs some time after the event. Using a combination of these points of verified information, the system approves the claim.

### Example 9

A customer files a disability claim. They become unable to work due to back injury. The customer calls the insurance company to file a disability claim. The company collects the information associated with the event. The system automatically validates that the medication that the claimant claims to take as a result of the injury is indicated for that type of injury. The system validates that the doctor identified as the attending physician is a licensed practitioner. The system generates an automated email confirmation of the doctor's visit and the customers claimed that they are disabled and unable to work and requests that the doctor respond immediately if the information provided is inaccurate. After two days in suspense, the system automatically approves the claim without further work.

The above specification, examples, and data provide a complete description of the automated loss verification system and associated method of the present invention. Since many embodiments of the invention can be made without departing from the spirit and scope of the invention, the invention resides in the claims hereinafter appended.

We claim:

1. An automated system having a database of information for processing a claim under a beneficial coverage contract issued by an insurance company or financial institution, such system comprising:
(a) identification of the beneficial coverage contract and facts characterizing a claimed loss event under the beneficial coverage contract;
(b)
means for assigning a risk assessment score via a statistical model or set of business rules by the insurance company or financial institution to the claim under the beneficial coverage contract for characterizing the risk that the claim is fraudulent or erroneous using statistical modeling techniques;
(c) means for associating with the risk assessment score for the claim a total confidence level (“TCL”) value required by the insurance company or financial institution for verifying the claimed loss event;
(d) means for pre-selecting a plurality of corroborating data sources with each one characterized by a confidence level value chosen or statistically modeled by the insurance company or financial institution for such data source's ability to verify the claimed loss event;
(e) means for automatically consulting one of the corroborating data sources to determine whether its informational content matches information provided by the claimant for the claimed loss event, and only in the event of a positive match, the pre-assigned confidence level value of the corroborating data source being added to an accumulated verification value (“AVV”) score for the claim;
(f) means for determining a remaining verification value (“RVV”) required to verify the claimed loss event by subtracting the AVV score from the TCL value (i.e., RVV=TCL−AVV);
(g) iterative repetition of steps (e) and (f) with successive corroborating data sources if the RVV value is less than the TCL value;
(h) in the event that the AVV score for the claims equals at least the required TCL value, treating the claim as verified for adjudication in accordance with the rules of the beneficial coverage contract for ultimate disposition; and
(i) treating the claim as unverified if the accumulated AVV value does not equal or exceed the required TCL value with no other corroborating data source available having a sufficient pre-assigned confidence level value that would bridge the difference between the AVV value and required TCL value if it was consulted by the system.

2. The automated claim processing system of claim 1 further comprising means for verifying that the claimant is entitled to claim a benefit under the beneficial coverage contract before the iterative utilization of steps (e) and (f) with corroborating data sources.

3. The automated claim processing system of claim 1 further comprising means for verifying that the claimant is entitled to claim a benefit under the beneficial coverage contract after at least the first iterative use of steps (e) and (f) with corroborating data sources.

4. The automated claim processing system of claim 1, wherein the ultimate disposition of the claim comprises payment of the claim to the claimant in accordance with the rules of the beneficial coverage contract pursuant to the verified claimed loss event.

5. The automated claim processing system of claim 1, wherein the ultimate disposition of the claim comprises a request for customer-provided loss verification of the claimed loss event pursuant to an unverified claimed loss event following application of the automated verification processing using the corroborating data sources to the claim.

6. The automated claim processing system of claim 1 further comprising in the event that at least one additional corroborating data source becomes available for automatic consultation by the system during the processing of the claim:
(j) means for calculating the maximum verification value (“MVV”) for all of the corroborating data sources available at any time during the processing of the claim;
(k) means for calculating the present verification value (“PVV”) as the aggregate confidence point values for the particular corroborating data sources available during the present iteration of steps (e) and (f);
(l) means for calculating the running present verification value (“RPVV”) as sum of the prior RPVV value and the PVV value for the available corroborating data sources during the present iteration of steps (f) and (g) (i.e., RPVV=RPVV+PVV);
(m) only proceeding with the iteration of steps (f) and (g) if PVV>0; and
(n) only proceeding with the iteration of steps (f) and (g) for the available corroborating data sources if RVV>MVV−RPVV.

7. The automated claim processing system of claim 1, wherein the beneficial coverage contract comprises an insurance policy.

8. The automated claim processing system of claim 5, wherein the insurance policy is selected from the group of short-term or long-term disability insurance, health insurance, critical illness insurance, dental insurance, term life insurance, whole life insurance, universal or variable life insurance, annuities, fire insurance, homeowner's insurance, tornado or hurricane insurance, flood insurance, automobile insurance, marine insurance, and other forms of property and casualty insurance.

9. The automated claim processing system of claim 1, wherein the beneficial coverage contract comprises a debt protection contract.

10. The automated claim processing system of claim 1 further comprising a rule set for automatically choosing the corroborating data source to be matched against the claimed loss event information based upon its suitability for verifying the loss event in a cost-effective manner.

11. The automated claim processing system of claim 8, wherein the suitability of the corroborating data sources comprises its access cost.

12. The automated claim processing system of claim 8, wherein the suitability of the corroborating data sources comprises its hit rate.

13. The automated claim processing system of claim 8, wherein the suitability of the corroborating data sources comprises the comparison of the confidence level value of the corroborating data source with the RVV value for the claim.

14. The automated claim processing system of claim 1, wherein the corroborating data source is an internal database maintained by the insurance company, financial institution, or system operator.

15. The automated claim processing system of claim 1, wherein the corroborating data source is an external database sourced from a third party.

16. An automated system having a database of information for processing a claim under a beneficial coverage contract issued by an insurance company or financial institution, such system comprising:
(a) identification of the beneficial coverage contract and facts characterizing a claimed loss event under the beneficial coverage contract;
(b) means for assigning a single score combining the relative risk assessment of the claimant, the claimed loss event, and one or more pre-selected corroborating data sources using statistical modeling techniques representing a confidence level that the claim is not fraudulent or erroneous;
(c) means for automatically consulting the one or more corroborating data sources to determine whether its informational content matches information provided by the claimant for the claimed loss event;
(d) only in the event of a positive match, treating the claim as verified for adjudication in accordance with the rules of the beneficial coverage contract for ultimate disposition; and
(e) treating the claim as unverified if there is not a positive match.
